(19) United States
(12) Patent Application Publication
(10) Pub. No.: US 2026/0295537 A1
(43) Pub. Date: Oct. 1, 2026

(54) CASSETTE

(71) Applicant: Donaldson Company, Inc., Bloomington, MN (US)

(72) Inventors: Matthew P. Brownson, Stillwater, MN (US); Benjamin C. Druecke, Hudson, WI (US); Edmund O’Neill, Victoria, MN (US); Daniel J. Dotzler, Webster, MN (US); Suresh B. Bommineni, Shakopee, MN (US); Cory C. Padesky, Edina, MN (US); Raymond S. Cleveland, Minneapolis, MN (US); Graham Temples, Greenville, SC (US)

(21) Appl. No.: 19/578,592

(22) Filed: Mar. 25, 2026

Related U.S. Application Data
(60) Provisional application No. 63/777,362, filed on Mar. 25, 2025.

(51) Int. Cl. B01D 63/08

(52) U.S. Cl. CPC B01D 63/0822; B01D 2313/041; B01D 2313/08; B01D 2313/105; B01D 2313/125; B01D 2313/13; B01D 2313/16

(57) ABSTRACT

The present disclosure relates to a cassette including an inlet cassette plate, an outlet cassette plate configured to be arranged in a stack with the inlet cassette plate, and a separation layer disposed therebetween. The inlet cassette plate defines a cassette inlet and an inlet channel in fluid communication with the cassette inlet, the inlet channel extending across the inlet cassette plate. The outlet cassette plate defines a cassette outlet opposite the cassette inlet in a longitudinal direction and an outlet channel in fluid communication with the cassette outlet. The outlet channel extends across the outlet cassette plate. The inlet cassette plate and the outlet cassette plate define a snap fit. A separation layer is disposed between the inlet cassette plate and the outlet cassette plate. A seal is disposed perimetrically around the separation layer axially between the inlet cassette plate and the outlet cassette plate. The snap fit, when engaged, achieves an intermediate seal pressure that is less than an operating seal pressure of the cassette.

This application claims the benefit of U.S. Provisional Application No. 63/777,362 filed Mar. 25, 2025, the disclosure of which is incorporated by reference in its entirety.

### TECHNOLOGICAL FIELD

The present disclosure is generally related to a cassette. More particularly, the present disclosure is related to a cassette with tailored flow channels.

### BACKGROUND

Cassettes may be used, for example, in tangential flow filtration (TFF), various separation or filtration applications, etc. Various situations require larger fluid volumes or faster fluid flow. Such situations may thus require more than one cassette to be used simultaneously. For example, various parallel and serial cassettes in a cassette assembly may be used. An improper number of cassettes, an improper alignment of cassettes in an assembly, an improper level of pressure within the cassette assembly, and other factors can interfere with operations of the components and equipment.

It can also be desirable to promote uniform fluid flow laterally and longitudinally across a first side of a separation layer disposed within the cassette, axially through the separation layer, and laterally and longitudinally across an opposite side of the separation layer once the fluid has passed through the separation layer. Such uniform flow may improve cassette performance. Uniform flow may also result in more consistent and more easily controlled pressures within the individual cassettes and within the cassette assembly. Consequently, the cassette may have an inlet channel that brings fluid to a separation layer in a manner which promotes uniform flow.

It can also be desirable to remove gases from the cassette to promote consistent pressure and fluid flow during use.

### SUMMARY

The technology disclosed herein relates to a cassette with various singular and modular configurations, which allows for the assembly to be adaptable to a variety of operating conditions and environments. A cassette may include tailored flow channels at one or both of an inlet and an outlet channel. The tailored flow channels may improve flow distribution of fluid introduced into the cassette compared to currently known cassettes. More specifically, fluid may evenly distribute through the inlet and outlet channels, and pressure across separation layer has improved uniformity. Fluid flux across the separation layer also has improved uniformity. Thus, adsorption or elution of a target molecule adsorbed to the separation layer also has improved uniformity.

Cassette assemblies can incorporate one or more cassettes and can be modified relatively easily to incorporate additional cassettes or fewer cassettes. In cassette assemblies having multiple cassettes, at least two of such cassettes may be arranged in parallel for fluid flow. A fluid inlet of a cassette may be fluidically coupled to another of the multiple cassettes in the assembly for parallel flow through the fluidically coupled cassettes in the assembly. A fluid outlet of a cassette may be fluidically coupled to another of the multiple cassettes in the assembly for parallel flow through each of the fluidically coupled cassettes in the assembly. In one or more embodiments, the cassettes may each be further configured to receive removable plugs to selectively obstruct a particular flow path defined by a particular cassette based on the position of the cassette within the assembly. In one or more embodiments, external tubing and external clamps may be configured to selectively obstruct a particular flow path defined by a particular cassette. Such configurations further allow for modularity of the cassette assembly.

In one or more embodiments, a cassette may include an inlet cassette plate defining a cassette inlet. The inlet cassette plate may define an inlet channel in fluid communication with the cassette inlet. The inlet channel may extend across the inlet cassette plate. The inlet channel may define an inlet channel depth in an axial direction. The cassette may further include an outlet cassette plate configured to be arranged in a stack with the inlet cassette plate. The outlet cassette plate may define a cassette outlet opposite the cassette inlet in a longitudinal direction. The outlet cassette plate may define an outlet channel in fluid communication with the cassette outlet. The outlet channel may extend across the outlet cassette plate. The outlet channel may define an outlet channel depth in the axial direction. The cassette may further include a separation layer disposed between the inlet cassette plate and the outlet cassette plate. The inlet channel may be in fluid communication with the outlet channel through the separation layer to form an assembly flow path. The inlet channel may extend along an effective inlet surface area of the separation layer and the outlet channel may extend along an effective outlet surface area of the separation layer. The inlet channel depth may define an inlet slope in the longitudinal direction, and the outlet channel depth may define an outlet slope in the longitudinal direction.

In one or more embodiments, a cassette may include an inlet cassette plate defining a cassette inlet. The inlet cassette plate may define an inlet channel in fluid communication with the cassette inlet. The inlet channel may extend across the inlet cassette plate. The inlet channel may define an inlet channel depth in an axial direction. The cassette inlet may extend diagonally relative to a longitudinal direction and a lateral direction. The cassette may further include an outlet cassette plate configured to be arranged in a stack with the inlet cassette plate. The outlet cassette plate may define a cassette outlet opposite the cassette inlet in the longitudinal direction. The outlet cassette plate may define an outlet channel in fluid communication with the cassette outlet. The outlet channel may extend across the outlet cassette plate. The outlet channel may define an outlet channel depth in the axial direction. The cassette outlet may extend diagonally relative to the longitudinal and lateral directions. The cassette may further include a separation layer disposed between the inlet cassette plate and the outlet cassette plate. The inlet channel may be in fluid communication with the outlet channel through the separation layer to form an assembly flow path. The inlet channel may extend along an effective inlet surface area of the separation layer and the outlet channel may extend along an effective outlet surface area of the separation layer.

In one or more embodiments, a cassette may include an inlet cassette plate defining a cassette inlet. The inlet cassette plate may define an inlet distribution channel extending laterally across the inlet cassette plate from the cassette inlet. The inlet cassette plate may define an inlet channel extending longitudinally from the inlet distribution channel across the inlet cassette plate. The inlet channel may define an inlet channel depth in an axial direction. The inlet distribution channel may narrow from the cassette inlet. The cassette may further include an outlet cassette plate configured to be arranged in a stack with the inlet cassette plate. The outlet cassette plate may define a cassette outlet opposite the cassette inlet in the longitudinal direction. The outlet cassette plate may define an outlet distribution channel extending laterally across the outlet cassette plate from the cassette outlet. The outlet cassette plate may define an outlet channel extending longitudinally from the outlet distribution channel across the outlet cassette plate. The outlet channel may define an outlet channel depth in the axial direction. The outlet distribution channel may narrow from the cassette outlet. The cassette may further include a separation layer disposed between the inlet cassette plate and the outlet cassette plate. The inlet channel may be in fluid communication with the outlet channel through the separation layer to form an assembly flow path. The inlet channel may extend along an effective inlet surface area of the separation layer and the outlet channel may extend along an effective outlet surface area of the separation layer.

In one or more embodiments, a cassette may include an inlet cassette plate defining a cassette inlet. The inlet cassette plate may define an inlet channel in fluid communication with the cassette inlet. The inlet channel may extend across the inlet cassette plate. The inlet channel may define an inlet channel depth in an axial direction. The cassette may further include an outlet cassette plate configured to be arranged in a stack with the inlet cassette plate. The outlet cassette plate may define a cassette outlet opposite the cassette inlet in a longitudinal direction. The outlet cassette plate may define an outlet channel in fluid communication with the cassette outlet. The outlet channel may extend across the outlet cassette plate. The outlet channel may define an outlet channel depth in the axial direction. The inlet cassette plate and the outlet cassette plate may define a snap fit. The cassette may further include a separation layer disposed between the inlet cassette plate and the outlet cassette plate. The cassette may further include a seal disposed perimetrically around the separation layer axially between the inlet cassette plate and the outlet cassette plate. The snap fit, when engaged, may achieve an intermediate seal pressure that is less than an operating seal pressure of the cassette. The inlet channel may be in fluid communication with the outlet channel through the separation layer to form an assembly flow path. The inlet channel may extend along an effective inlet surface area of the separation layer and the outlet channel may extend along an effective outlet surface area of the separation layer.

In one or more embodiments a cassette assembly is disclosed. A first end plate extends in a longitudinal and the lateral direction. A second end plate is configured to be coupled to the first end plate. The second end plate extends in the lateral and the longitudinal direction. A base extends axially outward from the first end plate towards the second end plate. The base is configured to rest on a planar surface. A cassette is configured to be disposed between the first end plate and the second end plate. The first end plate and the second end plate are configured to exert a compression force on the cassette.

In some such embodiments, the cassette has a cassette inlet and a cassette outlet, and the cassette inlet is positioned towards the base relative to the cassette outlet. Additionally or alternatively, the cassette inlet is configured to be positioned vertically below the cassette outlet when the base rests on a planar surface. Additionally or alternatively, the base is configured to extend beyond the second end plate. Additionally or alternatively, the assembly has a plurality of fasteners, and the cassette, the first end plate, and the second end plate each define a plurality of aligned fastener openings that are configured to receive each of the plurality of fasteners. Additionally or alternatively, the cassette assembly has one or more additional cassettes, wherein each of the one or more additional cassettes are configured to be arranged in a stacked configuration between the first end plate and the second end plate.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF THE DRAWINGS

FIG. 1 is a first perspective view of an example cassette consistent with various embodiments.

FIG. 2 is an exploded perspective view consistent with the example of FIG. 1.

FIG. 3 is another exploded perspective view consistent with the example of FIGS. 1-2.

FIG. 4 is a perspective cross-section view consistent with the example of FIGS. 1-3.

FIG. 5 is a detail view of a cross-section of a portion of a cassette consistent with the example of FIGS. 1-4.

FIG. 6 is a facing view of an example channel spacer consistent with some examples.

FIG. 7 is a first perspective view of an example cassette consistent with various embodiments.

FIG. 8 a perspective cross-section view consistent with the example of FIG. 7.

FIG. 9 is another perspective cross-section view consistent with the example of FIGS. 7-8.

FIG. 10 is a detail partial cross-sectional detail view of the example cassette consistent with FIGS. 7-9.

FIG. 11 is a first perspective view of an example cassette assembly consistent with various embodiments.

FIG. 12A is a perspective cross-section view consistent with the example of FIG. 11.

FIG. 12B is a partial close-up view of FIG. 12A.

FIG. 12C is a second partial close-up view of FIG. 12A.

FIG. 13 is a partial exploded view of an example cassette consistent with some examples.

FIG. 14 is a plan view of the inner side of an example cassette plate.

FIG. 15 is a cross-sectional view along line A-A of the cassette of FIG. 14.

FIG. 16 is a perspective view of an example cassette plate consistent with examples.

FIG. 17 is a plan view of an inner side of another example cassette plate consistent with various embodiments.

FIG. 18 is a partial perspective view of the cassette plate of FIG. 17.

FIG. 19 is a perspective view of example pillars consistent with various examples.

FIG. 20 is a perspective view of example flow through pillars consistent with various examples.

FIG. 21 is a perspective view of an example cassette plate consistent with various examples.

FIG. 22 is a cross-sectional view of a cassette assembly having a cassette plate of FIG. 21, where the cross-section is consistent with line B-B of FIG. 21.

FIG. 23 is a perspective cross-sectional view along line B-B of the cassette assembly of FIG. 22.

FIG. 24 is a perspective view of a cassette consistent with various examples.

FIGS. 25A and 25B are example data illustrating pressure at various positions along the length of a cassette.

FIGS. 26A and 26B are example data illustrating transmembrane flux at various positions along the length of the cassette of FIGS. 25Aand 25B, respectively.

FIGS. 27A and 28A are example data illustrating cross-sectional flow area at various positions along the length of a cassette.

FIGS. 27B and 28B are example data illustrating transmembrane flux at various positions along the length of the cassette of FIGS. 27A and 28A, respectively.

FIG. 29 is example data illustrating salt breakthrough at various cross-sectional flow area ratios.

FIG. 30 is a perspective view of an example cassette consistent with various embodiments.

FIG. 31 is another perspective view of the inlet cassette plate of FIG. 30.

FIG. 32 is a detail view of an example flow channel consistent with the technology disclosed herein.

FIG. 33 is a second detail view of the example flow channel of FIG. 32.

FIG. 34 is a perspective view of an example cassette assembly consistent with the technology disclosed herein.

FIG. 35 is an example graphic representation of channel depth consistently with a cubic root channel equation.

FIG. 36 is an example graphic representation of channel depth approximated by a cubic root channel equation.

The present technology may be more completely understood and appreciated in consideration of the following detailed description of various embodiments in connection with the accompanying drawings.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION

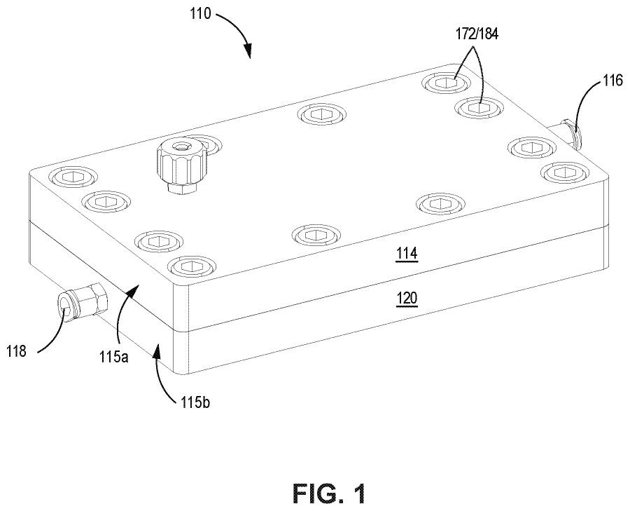

Cassettes consistent with the technology disclosed herein can have a variety of different configurations. FIGS. 1-5 depict one example embodiment of a cassette 110 that can be viewed together with the following description. The cassette 110 is generally configured to separate one or more constituents of a fluid that is passed therethrough. The cassette 110 generally has an inlet cassette plate 114, an outlet cassette plate 120, and a separation layer 130. The present disclosure does not limit the flow direction to any specific orientation.

The cassette 110 has an inlet cassette plate 114, an outlet cassette plate 120, and a separation layer 130 disposed between the inlet cassette plate 114 and the outlet cassette plate 120. The outlet cassette plate 120 can be configured to be arranged in a stack with the inlet cassette plate 114. For purposes of the present disclosure, the outlet cassette plate 120 and the inlet cassette plate 114 are stacked in the axial direction.

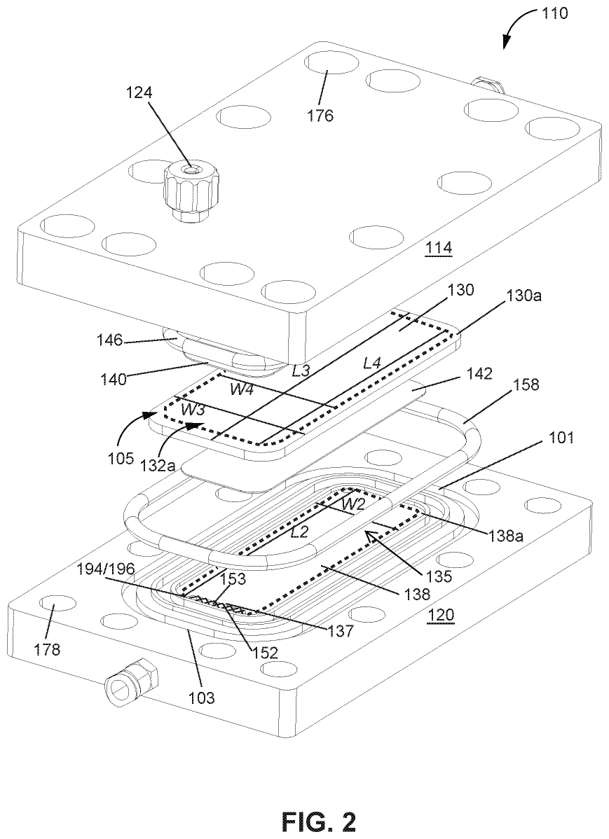

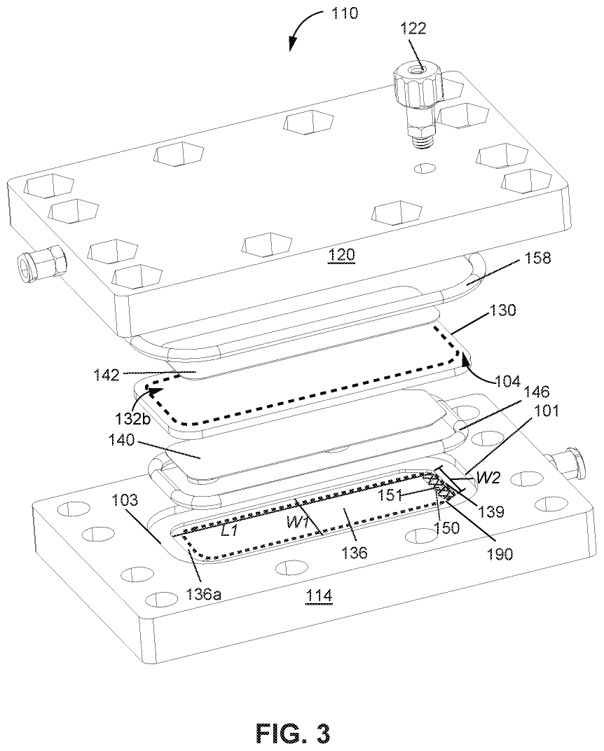

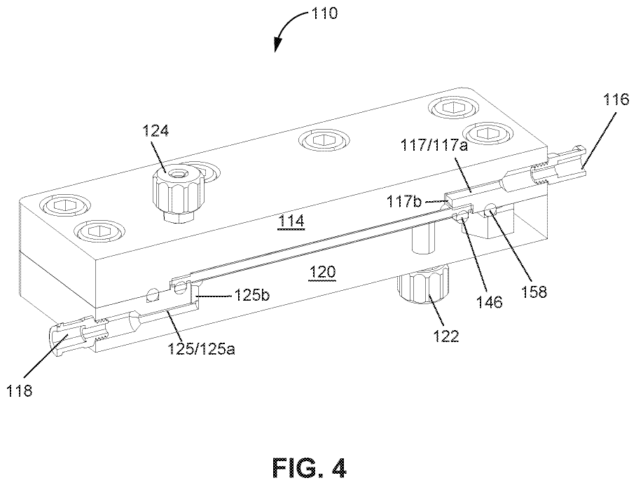

The inlet cassette plate 114 can define a cassette inlet 116 (particularly visible in FIG. 4). The cassette inlet 116 can be positioned towards a first longitudinal end 101 (FIGS. 2-3). The longitudinal direction is defined as a direction orthogonal to both the axial direction and the lateral direction (e.g., extending along a length of the cassette). The lateral direction as used herein is defined as a direction orthogonal to the axial direction along a width of the cassette. The width of the cassette is generally smaller than the length of the cassette. The inlet cassette plate 114 can define an inlet cassette vent 124 (FIGS. 2, 4). The cassette inlet 116 defines a path for inlet fluid flow from an assembly inlet 110a (FIG. 1) into the inlet cassette plate 114. The inlet cassette vent 124 selectively defines a path for gas to vent out of the inlet cassette plate 114 prior to or during use. The inlet cassette vent 124 may be open or closed to an ambient environment. The cassette inlet 116 can extend longitudinally into the inlet cassette plate 114. The inlet cassette vent 124 can extend axially through the inlet cassette plate 114.

The outlet cassette plate 120 of each cassette 110 can define a cassette outlet 118 (FIG. 4). The cassette outlet 118 can be positioned towards a second longitudinal end 103 (FIG. 2-3). The outlet cassette plate 120 can define an outlet cassette vent 122 (FIGS. 3-4). The cassette outlet 118 defines a path for outlet fluid flow from an assembly outlet 110b. The outlet cassette vent 122 defines a path for gas to vent out of the outlet cassette plate 120 prior to or during use. The cassette outlet 118 can extend longitudinally into the outlet cassette plate 120. The outlet cassette vent 122 can extend axially through the outlet cassette plate 120. The outlet cassette vent 122 can be open or closed to the ambient environment. The cassette inlet 116 can be generally configured for fluid communication with the cassette outlet 118.

In various embodiments, the cassette inlet 116 and the cassette outlet 118 are in fluid communication via the separation layer 130 of the cassette 110. The separation layer 130 is disposed between the inlet cassette plate 114 and the outlet cassette plate 120. The separation layer 130 can extend from the first longitudinal end 101 to the second longitudinal end 103. The separation layer 130 can define a total inlet surface area 104 (FIG. 2) and a total outlet surface area 105 (FIG. 3).

The separation layer 130 is generally configured to receive a fluid stream flowing from the cassette inlet 116 to the cassette outlet 118. The separation layer is configured to separate at least one component in the fluid stream from the fluid stream. Such separation may be realized through one or more of the following processes: chemical binding, binding of biological molecules, particle capture, absorption, adsorption, etc., as the fluid flows along and/or through the separation layer. The separation layer may include a single layer or a plurality of layers. The separation layer 130 is a fibrous mass in some embodiments. In some embodiments the separation layer 130 can be a particulate mass. The separation layer 130 is a single membrane in some embodiments. The separation layer 130 is a membrane stack in some embodiments. A membrane stack may include a plurality of membranes which are consecutively layered in the axial direction. The cassette inlet 116 can be configured to be in fluid communication with the cassette outlet 118 through the separation layer 130.

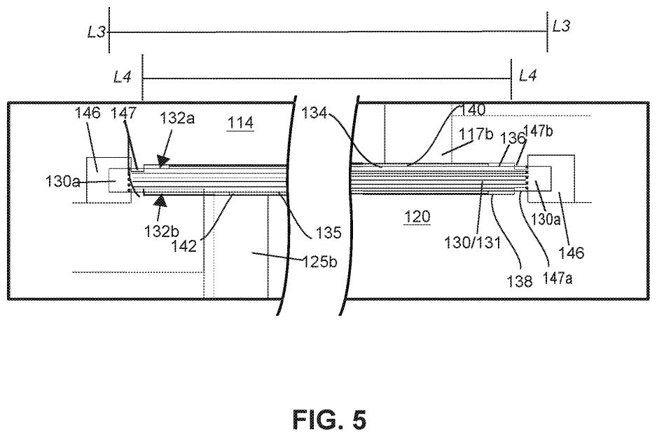

In embodiments where the separation layer 130 includes a membrane stack, the separation layer 130 can include a plurality of membrane layers 131 (shown in FIG. 5). The number of membrane layers 131 is not particularly limited, but in some embodiments there can be between 1 and 150 membrane layers 131. In embodiments, the plurality of membrane layers 131 can include at least 10 membrane layers 131. In alternative embodiments, the plurality of membrane layers 131 can include at least 5, at least, 15, at least 19, at least 20, at least 30, at least 40, at least 50 membrane layers 131, at least 100 membrane layers 131, or at least 150 membrane layers, etc. In alternative embodiments, the plurality of membrane layers 131 can include less than 150, less than 100, less than 50, less than 45, less than 35, less than 25, less than 17, less than 9, less than 4 membrane layers 131 etc.

The membrane layers 131 can be constructed of a variety of different materials and combinations of materials. In various embodiments the membrane layers 131 incorporate a breathable membrane, such as polytetrafluoroethylene (PTFE) or other types of breathable membranes. The membrane layers 131 can be a laminate or composite that includes a breathable membrane, such as a PTFE laminated to a woven or non-woven support layer. In some embodiments the membrane layers 131 incorporate a microporous substrate. In some embodiments each of the membrane layers 131 is constructed of the same or a similar material. In some embodiments one or more of the membrane layers 131 are constructed of a different material than other membrane layers 131.

FIGS. 3-4 illustrate a detail view of a cross-section of a cassette 110 consistent with FIGS. 1-2. The cassette 110 can further define an inlet channel 136 and an outlet channel 138 (as illustrated in FIGS. 2-3). The inlet channel 136 generally defines a path for fluid flow from the cassette inlet 116 (FIG. 3) along a first lateral surface 134 of the separation layer 130. The outlet channel 138 generally defines a path for fluid flow along a second lateral surface 135 of the separation layer 130, which is opposite the first lateral surface 134. The outlet channel 138 extends in the axial direction from the separation layer 130 to the outlet cassette (FIG. 2).

The inlet channel 136 can extend from the cassette inlet 116. The inlet channel 136 can define an effective inlet surface area 132a of the separation layer 130. The “effective inlet surface area” 132a is defined as the surface area of the upstream surface of the separation layer 130, which is the first lateral surface 134, that is in fluid communication with the inlet channel 136. The effective inlet surface area 132a is partially defined by an effective length L4 and an effective width W4 (illustrated in FIGS. 2 and 5). The total length of the separation layer 130 is L3 and the total width of the separation layer 130 is W3 (FIGS. 2 and 5). The difference between L3 and L4 may be a result of features obstructing fluid flow through portions of the surfaces separation layer, such as a separation layer seal 146 (discussed further herein) or structures defined by the cassette plates 114, 120. The inlet channel 136 can extend longitudinally from the cassette inlet 116 (e.g., along a length of the cassette). The inlet channel 136 can extend laterally from the cassette inlet 116 (e.g., along a width of the cassette). The inlet channel 136 can extend axially between the inlet cassette plate 114 and the effective inlet surface area 132a of the separation layer 130 (e.g., along a height of the cassette). In some embodiments, the inlet channel 136 can have an axial depth. The axial depth may, for example, help direct fluid flow, accommodate axial expansion of the separation layer 130 with a portion of the axial depth remaining clear of the separation layer 130 to accommodate fluid flow, etc. Axial expansion of the separation layer 130 may result from fluid flow through the separation layer 130. In embodiments with a membrane stack, for example, the inlet channel 136 can be sized depending on, for example, the number of membrane layers 131, the material of the membrane layers 131, the desired fluid flow rate through the cassette 110, etc.

The effective inlet surface area 132a can define a first width towards the first longitudinal end 101. The effective inlet surface area 132a can define a second width towards the second longitudinal end 103. The inlet cassette plate 114 can define the first width. The inlet cassette plate 114 can define the second width. In some embodiments, the first width is less than the second width (as illustrated in FIG. 3). In alternative embodiments (not shown), the first width and the second width may be substantially the same, or the first width may be greater than the second width. In further alternative embodiments, the width of the effective inlet surface area 132a can taper from the first width to the second width.

The outlet channel 138 can extend from the cassette outlet 118. The outlet channel 138 can define an effective outlet surface area 132b of the separation layer 130. The “effective outlet surface area” is defined as the surface area of the downstream surface of the separation layer 130, which is the second lateral surface 135, that is in fluid communication with the outlet channel 138. The outlet channel 138 can extend laterally towards the cassette outlet 118. The outlet channel 138 can be in fluid communication with the cassette outlet 118. The outlet channel 138 can extend longitudinally from the cassette outlet 118. The outlet channel 138 can extend laterally from the cassette outlet 118. The outlet channel 138 can extend axially between the effective outlet surface area 132b of the separation layer 130 and the outlet cassette plate 120. In some embodiments, the outlet channel 138 can have an axial depth. The axial depth may, for example, help direct fluid flow, accommodate axial expansion of the separation layer 130 with a portion of the axial depth remaining clear of the separation layer 130 to accommodate fluid flow, etc. Axial expansion of the separation layer 130 may result from fluid flow through the separation layer 130. In embodiments with a membrane stack, for example, the outlet channel 138 can be sized depending on, for example, the number of membrane layers 131, the material of the membrane layers 131, the desired fluid flow rate through the cassette 110, etc.

In some embodiments, the inlet channel 136 can be defined by at least one of the inlet cassette plate 114, the separation layer 130, the effective inlet surface area 132a, and the cassette inlet 116. The outlet channel 138 can be defined by at least one of the outlet cassette plate 120, the separation layer 130, the effective outlet surface area 132b, and the cassette outlet 118. In some embodiments, the channels 136, 138 may be defined by any combination of the listed components, and additionally can be defined by one or more seals, discussed further herein.

The inlet channel 136 can extend from an inlet intermediate position 139 towards the second longitudinal end 103. The inlet intermediate position 139 can be between the first longitudinal end 101 and the second longitudinal end 103. The outlet channel 138 can extend from an outlet intermediate position 137 towards the first longitudinal end 101. The outlet intermediate position 137 can be between the first longitudinal end 101 and the second longitudinal end 103.

The inlet cassette plate 114 can further define an inlet flow guide 190 (FIG. 3) that defines a lateral taper along the inlet channel 136 towards the first longitudinal end 101. The inlet flow guide 190 may advantageously reduce or prevent backflow. In some embodiments, the inlet flow guide 190 may advantageously improve fluid flow uniformity across the width of the inlet channel 136. The inlet flow guide 190 can define the inlet channel 136 towards the first longitudinal end 101. The inlet flow guide 190 can define the first width W1. The inlet flow guide 190 can taper from the first width W1 to a second width W2.

The outlet cassette plate 120 can further define an outlet flow guide 194. The outlet cassette plate 120 can define the first width. The outlet cassette plate 120 can define the second width. The outlet flow guide 194 may advantageously reduce or prevent backflow mixing, where the fluid in the cassette does not flow laterally across an opposite side of the separation layer 130 once the fluid has passed through the separation layer 130. Thus, the outlet flow guide 194 may advantageously improve fluid flow uniformity across the entirety of the effective area of the separation layer 130. The outlet flow guide 194 can be positioned within the outlet channel 138 at the second longitudinal end 103. The outlet flow guide 194 can define the second width. The outlet flow guide 194 can taper from the first width to the second width.

The outlet flow guide 194 can be configured to fluidically seal an outlet backflow region 196 of the outlet cassette plate 120. The outlet backflow region 196 can include a volume of an outlet channel (discussed further herein) extending laterally outwards from the cassette outlet 118. The outlet flow guide 194 can be a chamfered wall or body (not shown) which fluidically seals the outlet backflow region 196 separate from the effective outlet surface area (FIG. 2).

The cassette 110 can further include a cassette inlet extension 117 (e.g., 117a, 117b) and a cassette outlet extension 125 (e.g., 125a, 125b), as illustrated in FIG. 4. These extensions are configured to fluidically couple the inlet and cassette outlets to the inlet and outlet channels, respectively. The cassette inlet extension 117 can be defined by the inlet cassette plate 114. The cassette inlet extension 117 can be configured to fluidically couple the cassette inlet 116 and the inlet channel 136. The cassette inlet extension 117 can include a first portion 117a and a second portion 117b (see FIG. 4). The first portion 117a can extend longitudinally from the cassette inlet 116 towards the inlet channel 136. In the current example, the second portion 117b extends axially from the first portion 117a to the inlet channel 136. The second portion 117b can be in fluid communication with the inlet channel 136 towards one longitudinal end of the inlet channel. In some embodiments, the second portion 117b can be in fluid communication with the inlet channel 136 at one longitudinal end of the inlet channel 136.

The cassette outlet extension 125 can be defined by the outlet cassette plate 120. The cassette outlet extension 125 can fluidically couple the cassette outlet 118 and the outlet channel 138 (FIG. 4). The cassette outlet extension 125 can include a first portion 125a and a second portion 125b. The first portion 125a can extend from the outlet channel 138 to the second portion 125b. The second portion 125b can extend from the first portion 125a to the cassette outlet 118. The first portion 125a can be fluidically coupled to the outlet channel 138 towards the opposite end of the effective length L4 (illustrated in FIG. 5) of the separation layer 130 relative to the inlet extension first portion 117a.

In alternative embodiments, the extensions do not define 90-degree segments relative to each other or the corresponding fluid flow path as shown and can instead define one or more curved segments. In further alternative embodiments, the inlet extension is a single segment that extends at an oblique angle from the cassette inlet 116 to the inlet channel 136 such that the inlet extension is not orthogonal to the cassette inlet 116 or the inlet channel 136. Similarly, the outlet extension 125 may define a single or multiple segments where at least one segment is curved. In some embodiments the outlet extension is a single segment that defines an oblique angle and extends from the outlet channel 138 to the cassette outlet 118 such that the outlet extension is not orthogonal to the cassette outlet 118 or the outlet channel 138.

The second portion 117b can extend laterally along at least a portion of the width W1 (as illustrated in FIG. 3) of the inlet channel 136. This may advantageously improve fluid flow uniformity across the entirety of the effective area of the separation layer 130. Similarly, in this example, the first portion 125a can extend laterally along at least a portion of the width W2 of the outlet channel 138 (as illustrated in FIG. 2). Such a configuration may advantageously improve fluid flow uniformity across the entirety of the effective area of the separation layer 130. Alternate examples are possible where one or both of the second portion 117b of the cassette inlet extension and the first portion 125a of the cassette outlet extension define an opening having a circular shape rather than an elongate slot.

The cassette inlet 116 can define an inlet opening 151 (FIG. 3) into the inlet channel 136. The inlet opening 151 can define an interface between the cassette inlet 116 and the inlet channel 136. The geometry of the inlet opening 151 may be any shape which effectively allows fluid flow through the cassette 110 (e.g., circular, ovate, square, rectangular, hexagonal, elongate slot, etc.). The geometry of the inlet opening 151 may be configured to advantageously improve fluid flow uniformity across the entirety of the effective area of the separation layer 130. The inlet opening 151 can define an elongate slot along the first width. The inlet opening 151 can extend laterally along a width of the effective inlet surface area 132a. The inlet opening 151 can be circular. Preliminary testing suggests that using an elongate slot geometry instead of a circular hole geometry in some implementations results in better flow distribution and flow uniformity across the entirety of the effective surface area of the separation layer 130, at least because an elongate slot provides better mixing of fluid, and lower pressures within the cassette 110. However, using a smaller geometry may advantageously result in less overall volume of fluid within the cassette 110.

The cassette outlet 118 can define an outlet opening 153 (FIG. 2) into the outlet channel 138. The outlet opening 153 can define an interface between the cassette outlet 118 and the outlet channel 138. The geometry of the outlet opening 153 may be any shape which effectively allows fluid flow through the cassette 110 (e.g., circular, ovate, square, rectangular, hexagonal, elongate slot, etc.). The outlet opening 153 can define an elongate slot along a second width. The outlet opening 153 can extend laterally along a width of the effective outlet surface area 132b. The outlet opening 153 can be circular. The geometry of the outlet opening 153 may be optimized to advantageously improve fluid flow uniformity across the entirety of the effective area of the separation layer 130. Preliminary testing suggests that using an elongate slot geometry instead of a circular hole geometry in some implementations results in better flow distribution and flow uniformity across the entirety of the effective surface area of the separation layer 130, at least because an elongate slot provides better mixing of fluid, and lower pressures within the cassette 110. However, using a smaller geometry may advantageously result in less overall volume of fluid within the cassette 110.

The inlet cassette plate 114 and the outlet cassette plate 120 can be constructed of a variety of different materials and combinations of materials. In some embodiments, one or both of the cassette plates 114, 120 is plastic. In other embodiments, one or both of the cassette plates 114, 120 is metal. In one example, one or both of the cassette plates 114, 120 are injection-molded, 3D printed, machined, or combinations thereof. In some embodiments the inlet cassette plate 114 is constructed of the same material as the outlet cassette plate 120. In some other embodiments the inlet cassette plate 114 is constructed of a different material than the outlet cassette plate 120.

FIG. 6 illustrates a laterally facing view of an example channel spacer, which may be inserted across the inlet and/or outlet channels 136, 138 to ensure, for example, that the separation layer 130 does not expand into and block the channels. The cassette 110 can further include one or more channel spacers 140, 142 that are each configured to be received by the inlet channel 136 and/or the outlet channel 138. In the current example, the cassette 110 has an inlet channel spacer 140 and an outlet channel spacer 142 (as illustrated in FIGS. 2 and 6). The inlet channel spacer 140 is generally configured to retain a minimum axial depth of the inlet channel 136 to maintain fluid flow along the inlet channel 136. As mentioned above, the axial depth of the inlet channel 136 may be reduced upon system use due to separation layer expansion, for example, and the inlet channel spacer 140 may advantageously oppose such expansion. The inlet channel spacer 140 can be positioned in the inlet channel 136. The inlet channel spacer 140 is positioned between the inlet cassette plate 114 and the separation layer 130. In some embodiments, the inlet channel spacer 140 abuts the inlet cassette plate 114 and the separation layer 130.

The cassette 110 can further include an outlet channel spacer 142. The outlet channel spacer 142 is generally configured to retain a minimum axial depth of the outlet channel 138 to accommodate fluid flow along the outlet channel 138. The axial depth of the outlet channel 138 may be reduced upon system use due to separation layer expansion, and the outlet channel spacer 142 may advantageously oppose such expansion. The outlet channel spacer 142 can be positioned in the outlet channel 138. The outlet channel spacer 142 is positioned between the outlet cassette plate 120 and the separation layer 130. In some embodiments, the outlet channel spacer 142 abuts the outlet cassette plate 120 and the separation layer 130.

The inlet channel spacer 140 and/or the outlet channel spacer 142 may be constructed of a variety of different materials and combinations of materials. In some embodiments, the channel spacer is constructed of a non-compressible material. Such a configuration may increase the compression forces that are transferred to the separation layer by the cassettes when the cassettes are compressed together, such as in preparation for use, which will be described in more detail below. In some embodiments, the channel spacer includes plastic. The channel spacer can include a woven or non-woven material such as a scrim layer. A scrim layer may advantageously facilitate fluid flow through it. In other embodiments, the channel spacer is constructed of metal. In one example, the channel spacer is injection-molded, 3D printed or the like. The channel spacer can be constructed of an elastomeric material such as, for example, rubber, silicone, polyurethane, or other elastomeric materials.

In some examples, a channel spacer is constructed of a relatively non-compressible material. The channel spacer can include a layer of mesh such as woven mesh or an extruded plastic netting. In an example, the channel spacer includes a rail mesh layer constructed of polypropylene. In some examples, the channel spacer includes a mesh layer and a scrim layer. In some such examples, the mesh layer is disposed between the cassette and the scrim layer, and the scrim layer is disposed between the mesh layer and the separation layer 130. In some embodiments, the channel spacer includes a first mesh layer and a second mesh layer. The first mesh layer can abut the cassette, the second mesh layer can abut the separation layer 130. In some such embodiments a scrim layer is disposed between the first mesh layer and the second mesh layer which may advantageously increase fluid flow. The channel spacer can be retained with friction and/or compression forces. Such friction forces can be, for example, between the channel spacer and the separation layer 130, and between the channel spacer and the corresponding cassette plate 114, 120.

The channel spacers 140, 142 generally define openings to accommodate fluid flow through the channel spacers 140, 142 along the corresponding channel to the separation layer 130. In some embodiments the openings can include lateral openings and axial openings. In some embodiments the openings can include longitudinal openings. In some embodiments, at least one of the inlet channel spacer 140 and the outlet channel spacer 142 can include ridges 144 extending across the separation layer 130, an example of which is illustrated in FIG. 6. The ridges 144 are generally configured to define a structure to retain the axial depth of the respective channel for fluid flow. The ridges 144 may advantageously provide rigidity to the respective spacer. The ridges 144 may further advantageously guide fluid flow across the surface area of the separation layer 130.

The ridges 144 may extend laterally along at least a portion of the channel width of the respective channel within which the spacer is positioned. The ridges have a width in the longitudinal direction and a height in the axial direction. The ridges 144 may extend axially between the separation layer 130 and the adjacent cassette plate.

In some embodiments, the cassette 110 includes at least one of an inlet retaining feature 150 and an outlet retaining feature 152, as illustrated in FIGS. 2-3. The inlet and outlet retaining features 150, 152 may advantageously prevent the separation layer 130 from deforming into the cassette inlet 116 and the cassette outlet 118, respectively. The inlet and outlet retaining features 150, 152 may not be configured to cover as much of the inlet and cassette outlets 116, 118, respectively, compared to the one or more channel spacers 140, 142, which may be configured to cover more of the inlet and cassette outlets 116, 118, respectively. In some embodiments, the cassette 110 may include the one or more channel spacers 140, 142 and the one or more retaining features 150, 152. In alternative embodiments, the cassette 110 may include only the channel spacers 140, 142 without the retaining features 150, 152. In further alternative embodiments, the cassette 110 may include only the retaining features 150, 152, without the channel spacers 140, 142. The channel spacers 140, 142 may not prevent such deformation of the separation layer 130 to an optimized extent, and instead may advantageously provide flow distribution. In embodiments with both the channel spacers 140, 142 and the retaining features 150, 152, the channel spacers 140, 142 may or may not laterally align, or overlay, the retaining features 150, 152.

The inlet retaining feature 150 may be configured to cover an inlet opening 151 of the cassette inlet 116. The inlet retaining feature 150 may extend across the inlet opening 151 of the cassette inlet 116. The inlet opening 151 of the cassette inlet 116 may define an interface between the cassette inlet 116 and the inlet channel 136. The interface may be two-dimensional, and additionally may or may not be planar. For example, in some embodiments (and as illustrated), the interface may be substantially planar and may be substantially parallel to the separation layer 130. In alternative embodiments (not shown), the interface may be non-planar.

The outlet retaining feature 152 may be configured to cover an outlet opening 153 of the cassette outlet 118. The outlet retaining feature 152 may extend across the outlet opening 153 of the cassette outlet 118. The outlet opening 153 of the cassette outlet 118 may define an interface between the cassette outlet 118 and the outlet channel 138. The interface may be two-dimensional, and additionally may or may not be planar. For example, in some embodiments (and as illustrated), the interface may be substantially planar and may be substantially parallel to the separation layer 130. In alternative embodiments (not shown), the interface may be non-planar.

Preliminary testing suggests that using both the inlet retaining feature 150 and the outlet retaining feature 152 in some implementations results in better flow distribution and flow uniformity across the entirety of the effective surface area of the separation layer 130 and allows for the direction of the flow to be reversed at any time without undesirable expansion of the separation layer 130 into the inlet or cassette outlets 116, 118.

The inlet and outlet retaining features 150, 152 can be constructed of a variety of different materials and combinations of materials. In some embodiments, one or both of the retaining features 150, 152 is plastic and includes perforations therethrough for fluid flow. In other embodiments, one or both of the retaining features 150, 152 is metal and includes perforations therethrough for fluid flow. For example, in one embodiment, the inlet and/or outlet retaining features 150, 152 may be constructed of stainless steel. In one example, one or both of the retaining features 150, 152 are injection-molded, 3D printed, machined, or combinations thereof, and include perforations therethrough for fluid flow. In some embodiments the inlet retaining feature 150 is constructed of the same material as the outlet retaining feature 152. In some other embodiments the inlet retaining feature 150 is constructed of a different material than the outlet retaining feature 152.

The inlet and outlet retaining features 150, 152 may be connected to the inlet and outlet cassette plates 114, 120, respectively, using a weld, adhesive, or mechanical attachment. For example, the inlet and outlet retaining features 150, 152 may include one or more apertures around the perimeter of the inlet and outlet retaining features 150, 152, and each aperture may be melted to a boss on the respective cassette plates 114, 120. In some embodiments the inlet and outlet retaining features 150, 152 are not mechanically attached to the cassette plates and maintain their respective positions as a result of the compression forces exerted between the inlet cassette plate and the outlet cassette plate.

The cassette 110 can further include a separation layer seal 146 (FIGS. 2-4). The separation layer seal 146 is generally configured to seal among the separation layer and each of the inlet cassette plate 114 and the outlet cassette plate 120 so that fluid does not escape from between the plates during use. In various implementations, the separation layer seal 146 is configured to prevent fluid from bypassing axial flow through the separation layer, such as by flowing around the edges of the separation media. The separation layer seal 146 can be installed between the inlet cassette plate 114 and the outlet cassette plate 120. In some embodiments, the separation layer seal 146 can be in contact with the inlet cassette plate 114 and the outlet cassette plate 120. The separation layer seal 146 can be configured to fluidically seal a perimeter region 130a of the separation layer 130 (partially visible in FIG. 2), a perimeter region 136a (FIG. 3) of the inlet channel 136, and a perimeter region 138a (FIG. 2) of the outlet channel 138. In some embodiments, the separation layer seal 146 is defined by a relatively tight coupling of the cassette plates 114, 120 that forms a liquid tight seal via compression forces around the separation layer 130. In such an example, a separation layer seal that is a separate component than the cassette plates 114, 120 can be omitted.

The separation layer seal 146 may be constructed of a variety of different materials and combinations of materials. In various embodiments the separation layer seal 146 can be constructed of an elastomeric material such as rubber, silicone, polyurethane, and the like. In some other embodiments, the separation layer seal 146 is a molded plastic. In yet other embodiments, the separation layer seal 146 is a metal. In one example, the separation layer seal 146 is injection-molded, 3D printed or formed through other types of processes. The separation layer seal 146 can include an overmolded gasket. The overmolded gasket can be injection molded around the perimeter of the separation layer 130 to form the separation layer seal 146.

In alternative embodiments, the separation layer seal can be more than one seal. The separation layer seal 146 can include a first o-ring inserted between the perimeter region 130a on the first lateral surface 134 (such as the upstream surface) of the separation layer 130 and the inlet cassette plate 114. The separation layer seal 146 can include a second o-ring inserted between the perimeter region 130a on a second lateral surface 135 (such as the downstream surface) of the separation layer 130 and the outlet cassette plate 120. In further alternative embodiments, the separation layer seal 146 may be a weld, for example, or an adhesive. A weld may be formed between, or an adhesive may be used to seal together, the cassette plates 114, 120, or the separation layer 130 and the inlet cassette plate 114, or the separation layer 130 and the outlet cassette plate 120, or any combination thereof.

As illustrated in FIG. 5, in some embodiments, the inlet cassette plate 114 and the outlet cassette plate 120 can mutually define a compression structure 147 around the inlet channel 136 and the outlet channel 138. More particularly, in the current example the outlet cassette plate 120 defines an axially extending sidewall 147a around the outlet channel 138 that faces an opposing sidewall 147b of the inlet cassette plate 114 that surrounds the inlet channel 136. The axially extending sidewall 147a and the opposing sidewall 147b exert a compression force on the perimeter region 130a of the separation layer 130 that creates a fluid seal. The compression structure 147 may advantageously prevent fluid bypass therethrough.

The cassette 110 can further include an attachment seal 158 (FIGS. 2-4). The attachment seal 158 is generally configured to fluidically seal between the inlet and outlet cassette plates 114, 120. The attachment seal 158 can be inserted between the inlet cassette plate 114 and the outlet cassette plate 120. The attachment seal 158 can extend laterally around and outside of a periphery of the separation layer 130. The attachment seal 158 can be positioned laterally between the axial surfaces 115a, 115b (FIG. 1) of the inlet and outlet cassette plates 114, 120, respectively, and the separation layer seal 146. The attachment seal 158 can be constructed of a variety of different materials and combinations of materials consistent with those discussed above with reference to the separation layer seal. The attachment seal 158 may be retained with friction and/or compression forces, for example, and/or may be retained using fasteners 172 such as fasteners used to couple the inlet cassette plate 114 and the outlet cassette plate 120 under pressure. Such forces can be among the attachment seal 158, the inlet cassette plate 114 and the outlet cassette plate 120.

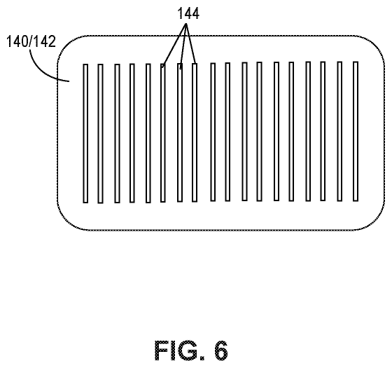

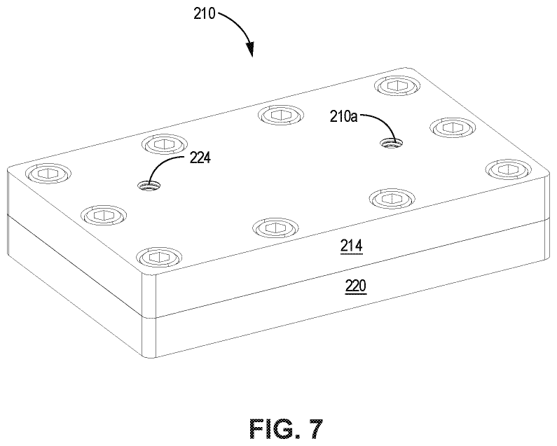

Cassettes consistent with the technology disclosed herein can have a variety of different configurations. FIGS. 7-9 depict perspective views of another example cassette 210, and FIGS. 7-9 can be viewed together with the following description. The cassette 210 is generally configured to receive a fluid that is passed therethrough and separate one or more constituents within the fluid. The cassette 210 generally has an inlet cassette plate 214, an outlet cassette plate 220, and a separation layer 230. It will be understood the components referenced in the description of FIGS. 7-9 herein are consistent with the descriptions of the same components described elsewhere herein unless contradictory to the current description or corresponding figures.

Similar to other embodiments described herein, cassette 210 has an inlet cassette plate 214, an outlet cassette plate 220, and a separation layer 230 disposed between the inlet cassette plate 214 and the outlet cassette plate 220. The outlet cassette plate 220 can be configured to be arranged in a stack with the inlet cassette plate 214. The inlet cassette plate 214 can define a cassette inlet 216 and an inlet cassette vent 224. The cassette inlet 216 defines a path for inlet fluid flow into the cassette 210 during use. The inlet cassette vent 224 defines a path for gas to flow out of the cassette 210 during use. The inlet cassette vent 224 can be open or closed to an ambient environment. The cassette inlet 216 can define an axial through-hole which extends axially through the inlet cassette plate 214. The inlet cassette vent 224 can similarly extend axially through the inlet cassette plate 214.

The outlet cassette plate 220 can define a cassette outlet 218 and an outlet cassette vent 222. The cassette outlet 218 defines a path for outlet fluid flow during use. The outlet cassette vent 222 defines a path for gas to flow out of the outlet cassette plate 220 during use. The cassette outlet 218 can define an axial through-hole which extends axially through the outlet cassette plate 220. The outlet cassette vent 222 can similarly extend axially through the outlet cassette plate 220. The outlet cassette vent 222 can be open or closed to the ambient environment. The cassette outlet 218 can be generally configured for fluid communication with the cassette inlet 216.

In various embodiments, the cassette inlet 216 and the cassette outlet 218 are in fluid communication via the separation layer 230 of the cassette 210. The separation layer 230 is disposed between the inlet cassette plate 214 and the outlet cassette plate 220. The separation layer 230 is generally configured to separate one or more constituents from a fluid stream flowing from the cassette inlet 216 to the cassette outlet 218. The cassette inlet 216 can be configured to be in fluid communication with the cassette outlet 218 through the separation layer 230. The separation layer 230 can be consistent with separation layers discussed above with reference to FIGS. 1-5.

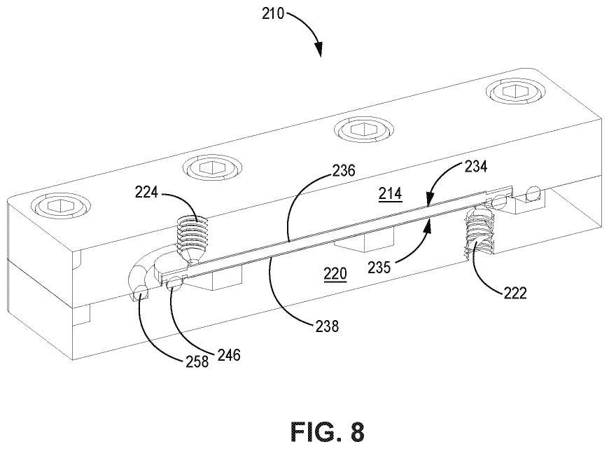

Each cassette 210 can further include an inlet channel 236 (as illustrated in FIG. 8) and an outlet channel 238 (as illustrated in FIG. 8). The inlet channel 236 generally defines a path for fluid flow from the cassette inlet 216 along a first lateral surface 234 of the separation layer 230 (FIG. 8). The outlet channel 238 generally defines a path for fluid flow along a second lateral surface 235 (FIG. 8) of the separation layer 230, which is opposite the first lateral surface 234. The outlet channel 238 extends from the separation layer 230 to the cassette outlet 218.

The inlet channel 236 extends along an effective inlet surface area (not shown) of the separation layer 230. The inlet channel 236 is similar to the inlet channel 136 described herein with respect to FIGS. 1-5. The outlet channel 238 extends along an effective outlet surface area (not shown) of the separation layer 230. The outlet channel 238 is similar to the outlet channel 138 described herein with respect to FIGS. 1-5.

The inlet channel 236 of the inlet cassette plate 214 defines an inlet channel length L1 and an inlet channel width W1, as illustrated in FIG. 3. In some embodiments, the ratio of the inlet channel length L1 to the inlet channel width W1 may advantageously result in a relative improvement in flow characteristics. The inlet channel length L1 can be between 1 and 4 times larger than the inlet channel width W1. In alternative embodiments, the inlet channel length L1 can be at least 1 time, at least 1.5 times, at least 2 times, at least 2.5 times, at least 3 times, at least 3.5 times, at least 4 times the inlet channel width W1, etc., and/or can be less than 4 times, less than 3.75 times, less than 3.25 times, less than 2.75 times, less than 2.25 times, less than 1.75 times, less than 1.25 times the inlet channel width W1, etc.

The outlet channel 238 of the outlet cassette plate 220 can define an outlet channel length L2 and an outlet channel width W2, as illustrated in FIG. 2. The outlet channel length L2 can have a ratio with the outlet channel width W2 consistent with that discussed above with respect to the inlet channel length L1 and the inlet channel width W1.

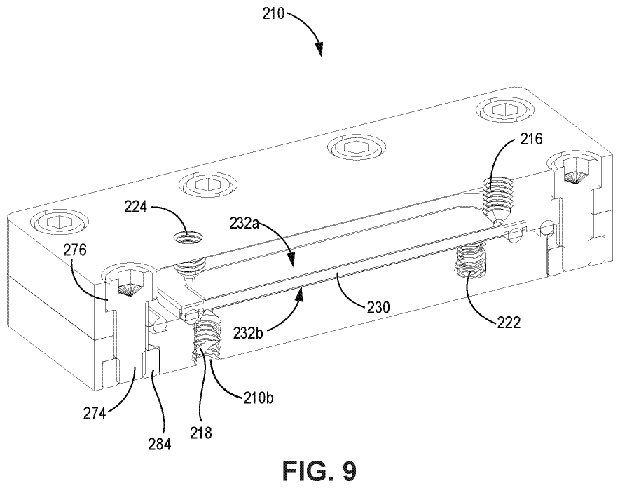

The separation layer 230 generally defines an effective inlet surface area 232a and an effective outlet surface area 232b (FIG. 9). The effective inlet surface area 232a has an effective length L4 and an effective width W4 (FIGS. 2 and 5). The effective inlet surface area 232a can be defined as the area of the separation layer 230 which is available to receive fluid flow. The effective inlet surface area 232a will generally be less than a total surface area of the separation layer 230. The separation layer can define a total length L3 (FIG. 2) and a total width W3 (FIG. 2). In the current example, a perimeter region of the separation layer 230 is pinched between the inlet plate 214 and the outlet cassette plate 220 and is not available to receive fluid flow, and thus does not define a portion of the effective area.

The effective length L4 can be between 1 times and 4 times larger than the effective width W4. In alternative embodiments, the effective length L4 can be at least 1 times, at least 1.5 times, at least 2 times, at least 2.5 times, at least 3 times, at least 3.5 times, or at least 4 times the effective width W4, etc. In alternative embodiments, the effective length L4 can be less than 4 times, less than 3.75 times, less than 3.25 times, less than 2.75 times, less than 2.25 times, less than 1.75 times, or less than 1.25 times the effective width W4, etc.

In some embodiments, the effective width W4 is equal to the width of the effective inlet surface area 232a and the width of the effective outlet surface area 232b. In alternative embodiments, the effective width W4 may be different at the effective inlet surface area 232a from the effective outlet surface area 232b such that there is an inlet effective width and an outlet effective width (not shown). In some embodiments, the effective length L4 is equal to the length of the effective inlet surface area 232a and the length of the effective outlet surface area 232b. In alternative embodiments, the effective length L4 of the effective inlet surface area 232a may be different than the effective length of the effective outlet surface area 232b such that there is an inlet effective length and an outlet effective length (not shown).

Each cassette 210 can further include one or more channel spacers that are each configured to be received by the inlet channel 236 and/or the outlet channel 238 as described with respect to FIGS. 1-5.

Each cassette 210 can further include a separation layer seal 246 (FIG. 8). The separation layer seal 246 is generally configured to seal among the separation layer and each of the inlet cassette plate 214 and the outlet cassette plate 220 so that fluid does not escape from between the plates during use. The separation layer seal 246 can be installed between the inlet cassette plate 214 and the outlet cassette plate 220. In some embodiments, the separation layer seal 246 can be in contact with the inlet cassette plate 214 and the outlet cassette plate 220. The separation layer seal 246 can be configured to fluidically seal a perimeter region of the separation layer 230 (not shown), a perimeter region of the inlet channel 236 (not shown), and a perimeter region of the outlet channel 238 (not shown). The separation layer seal 246 may be similar to the separation layer seal 146 described with respect to FIGS. 1-5.

The cassette 210 can further include an attachment seal 258. The attachment seal 258 is generally configured to fluidically seal between the inlet and outlet cassette plates 214, 220. The attachment seal 258 can be inserted between the inlet cassette plate 214 and the outlet cassette plate 220. The attachment seal 258 can extend laterally around a periphery of the separation layer seal 246. The attachment seal 258 may be similar to the attachment seal 158 described with respect to FIGS. 1-5.

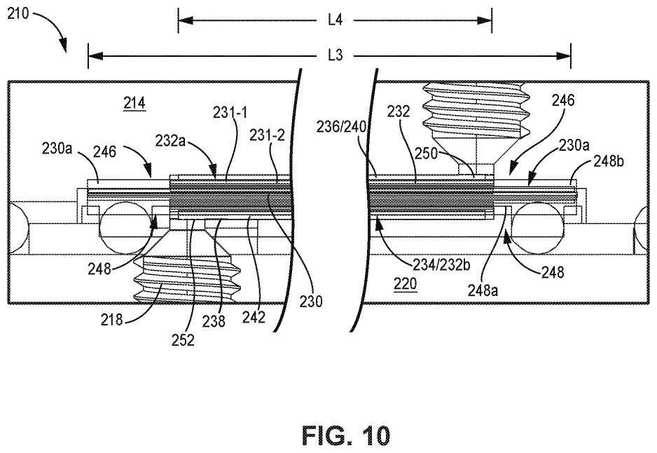

In some embodiments, the cassette 210 includes at least one of an inlet retaining feature 250 and an outlet retaining feature 252, as illustrated in FIG. 10. The inlet and outlet retaining features 250, 252 may advantageously prevent the separation layer 230 from deforming into the cassette inlet 216 and the cassette outlet 218, respectively. The inlet and outlet retaining features 250, 252 may not be configured to cover as much of the inlet and cassette outlets 216, 218, respectively, compared to the one or more channel spacers, which may be configured to cover more of the inlet and cassette outlets 216, 218, respectively. In some embodiments, the cassette 210 may include the one or more channel spacers and the one or more retaining features 250, 252. In alternative embodiments, the cassette 210 may include only the channel spacers without the retaining features 250, 252. In further alternative embodiments, the cassette 210 may include only the retaining features 250, 252, without the channel spacers. The channel spacers may not prevent such deformation of the separation layer 230 to an optimized extent, and instead may advantageously provide flow distribution. In embodiments with both the channel spacers and the retaining features 250, 252, the channel spacers may or may not laterally align, or overlay, the retaining features 250, 252.

The inlet retaining feature 250 may be configured to cover an inlet opening 251 of the cassette inlet 216. The inlet retaining feature 250 may extend across the inlet opening 251 of the cassette inlet 216. The inlet opening 251 of the cassette inlet 216 may define an interface between the cassette inlet 216 and the inlet channel 236. The interface may be two-dimensional, and additionally may or may not be planar. For example, in some embodiments (and as illustrated), the interface may be substantially planar and may be substantially parallel to the separation layer 230. In alternative embodiments (not shown), the interface may be non-planar.

The outlet retaining feature 252 may be configured to cover an outlet opening 53 of the cassette outlet 1128. The outlet retaining feature 252 may extend across the outlet opening 253 of the cassette outlet 218. The outlet opening 253 of the cassette outlet 218 may define an interface between the cassette outlet 218 and the outlet channel 238. The interface may be two-dimensional, and additionally may or may not be planar. For example, in some embodiments (and as illustrated), the interface may be substantially planar and may be substantially parallel to the separation layer 230. In alternative embodiments (not shown), the interface may be non-planar.

Preliminary testing suggests that using both the inlet retaining feature 250 and the outlet retaining feature 252 in some implementations results in better flow distribution and flow uniformity across the entirety of the effective surface area of the separation layer 230 and allows for the direction of the flow to be reversed at any time without undesirable expansion of the separation layer 230 into the inlet or cassette outlets 216, 218.

The inlet and outlet retaining features 250, 252 can be constructed of a variety of different materials and combinations of materials. In some embodiments, one or both of the retaining features 250, 252 is plastic and includes perforations therethrough for fluid flow. In other embodiments, one or both of the retaining features 250, 252 is metal and includes perforations therethrough for fluid flow. For example, in one embodiment, the inlet and/or outlet retaining features 250, 252 may be constructed of stainless steel. In one example, one or both of the retaining features 250, 252 are injection-molded, 3D printed, machined, or combinations thereof, and include perforations therethrough for fluid flow. In some embodiments the inlet retaining feature 250 is constructed of the same material as the outlet retaining feature 252. In some other embodiments the inlet retaining feature 250 is constructed of a different material than the outlet retaining feature 252.

The inlet and outlet retaining features 250, 252 may be connected to the inlet and outlet cassette plates 214, 220, respectively, using a weld, adhesive, or mechanical attachment. For example, the inlet and outlet retaining features 250, 252 may include one or more apertures around the perimeter of the inlet and outlet retaining features 250, 252, and each aperture may be melted to a boss on the respective cassette plates 214, 220.

### Cassette Assemblies

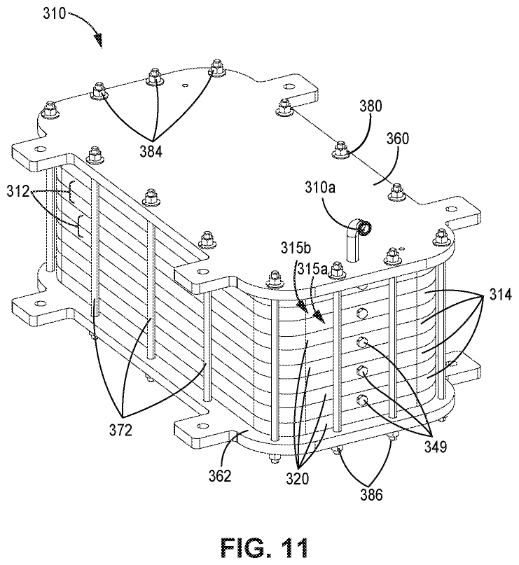

FIG. 11 is a perspective view of an example stacked cassette assembly 310 consistent with the technology disclosed herein. The cassette assembly 310 has an inlet cassette plate 314 and an outlet cassette plate 320. It will be understood the components referenced in the description of FIG. 11 herein are consistent with the descriptions of the same components described elsewhere herein unless contradictory to the current description or corresponding figures.

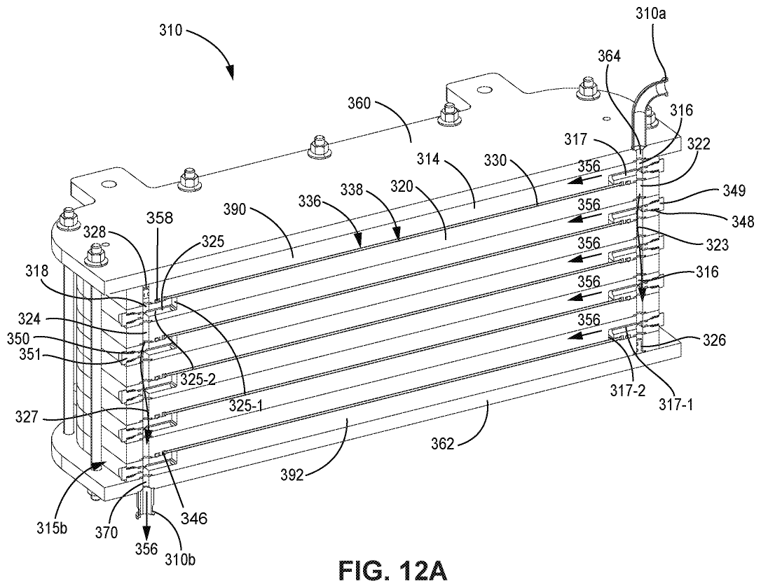

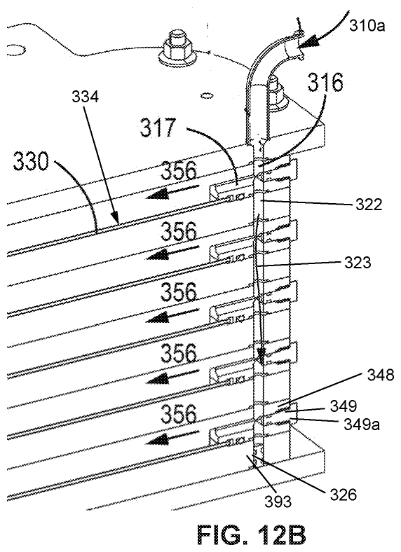

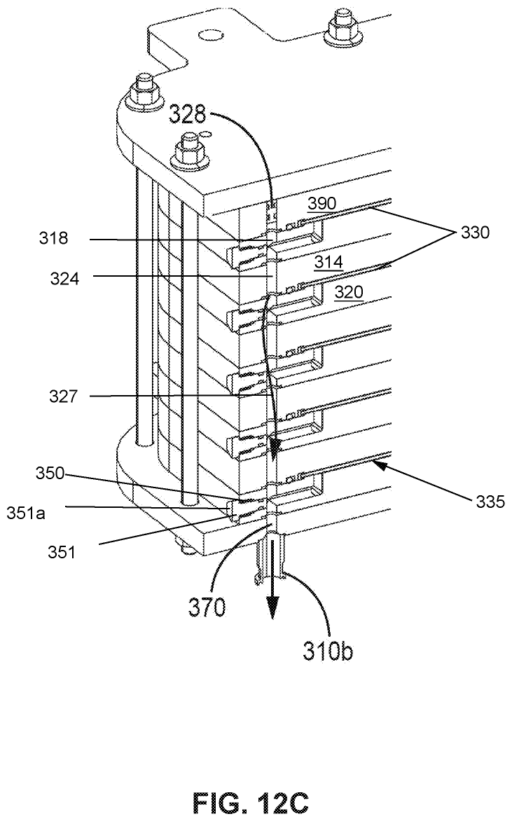

Cassette assemblies consistent with the technology disclosed herein can have a variety of different configurations. FIGS. 11-12C depict one example embodiment of a cassette assembly 310, and FIGS. 11-12C can be viewed together with the following description. The cassette assembly 310 is generally configured to separate one or more constituents from a fluid that is passed therethrough. The cassette assembly 310 generally has an inlet cassette plate 314, an outlet cassette plate 320, an inlet plug 326, an outlet plug 328, and a separation layer 330. As illustrated in FIGS. 11-12C, there are a plurality of cassettes 312 stacked within the cassette assembly 310. Each of the plurality of cassettes 312 are configured to separate one or more constituents from a fluid passing therethrough. The cassettes 312 are generally arranged in parallel with respect to fluid flow through the cassette assembly 310. Parallel fluid flow through multiple cassettes can accommodate increased fluid flow capacity and/or reduced pressure drop compared to fluid flow through a single cassette or compared to fluid flow through cassettes arranged in series. Parallel fluid flow through each of the cassettes in the assembly 310 is represented in FIG. 12A. In some implementations, however, there may be a single cassette 312 within the cassette assembly 310, as described herein.

As illustrated in FIG. 12B, the cassette assembly 310 has a cassette inlet 316. The cassette inlet 316 fluidically couples an assembly inlet 310a of the cassette assembly 310 to each of the individual cassettes 312 within the assembly 310. The cassette inlets 316 align and extend axially through each of the cassettes 312 in the cassette assembly 310 to form an inlet flow path 323 through the assembly.

As illustrated in FIG. 12C, each cassette in the cassette assembly 310 has a cassette outlet 318. The cassette outlet 318 fluidically couples an assembly outlet 310b of the cassette assembly 310 to each of the individual cassettes within the assembly. The cassette outlet 318 extends axially through each of the cassettes in the cassette assembly 310. The cassette outlets 318 align and extend axially through each of the cassettes 312 in the cassette assembly 310 to form an outlet flow path 327 through the assembly. The cassette inlet 316 and the cassette outlet 318 are in fluid communication through each of the cassettes. More particularly, the cassette inlet 316 and the cassette outlet 318 are in fluid communication through each separation layer 330 of each cassette. The present disclosure does not limit the flow direction to any specific orientation.

The cassette assembly 310 described herein is modular, and a user is able to include different numbers of cassettes into the cassette assembly 310. This may be advantageous as the cassette assembly 310 can be configured to accommodate a variety of different operating conditions.

Each individual cassette within the cassette assembly 310 has an inlet cassette plate 314, an outlet cassette plate 320, and a separation layer 330 disposed between the inlet cassette plate 314 and the outlet cassette plate 320. The outlet cassette plate 320 can be configured to be arranged in a stack with the inlet cassette plate 314. In some embodiments the assembly 310 has a single inlet cassette plate 314 and a single outlet cassette plate 320 in an assembly that has a single cassette 312. In some implementations, such as in the assembly of FIGS. 11-12C, the assembly 310 includes more than one inlet cassette plate 314 and more than one outlet cassette plate 320 where there is more than one cassette in the assembly 310.

Each inlet cassette plate 314 can define a cassette inlet 316 (particularly visible in FIG. 12B) and an outlet conduit 324 (FIG. 12C). The cassette inlet 316 defines a path for fluid flow from the assembly inlet 310a into the cassette 312 during use. The outlet conduit 324 defines a path for outlet fluid flow out of the cassette 312 during use. The cassette inlet 316 can extend axially through the inlet cassette plate 314. The outlet conduit 324 can extend axially through the inlet cassette plate 314. The cassette inlet 316 is generally configured for fluid communication with the outlet conduit 324.

The outlet cassette plate 320 of each cassette assembly 310 can define an inlet conduit 322 (FIG. 12B) and the cassette outlet 318 (FIG. 12C). The inlet conduit 322 defines a flow path for fluid flow from the cassette inlet 316 of a first inlet cassette plate to a cassette inlet 316 of a second inlet cassette plate during use. The cassette outlet 318 defines a path for outlet fluid flow during use. The inlet conduit 322 can extend axially through the outlet cassette plate 320. The cassette outlet 318 can extend axially through the outlet cassette plate 320. The inlet conduit 322 can be generally configured for fluid communication with the cassette inlet 316, as described further herein. The inlet conduit 322 can be generally configured for fluid communication with the cassette outlet 318. The inlet conduit 322 can be generally configured for fluid communication with the outlet conduit 324.

The cassette inlet 316 can be configured to be laterally and longitudinally aligned with the inlet conduit 322, which together form a portion of the inlet flow path 323 of the assembly 310. “Laterally and longitudinally aligned” is used herein to mean that the cassette inlets 316 and inlet conduits 322 overlap in the lateral and longitudinal directions. In embodiments where the cassette assembly has a generally rectangular profile through a cross section orthogonal to the axial direction, the longitudinal length can be greater than the lateral length. The axial direction is parallel to the direction of stacking of the inlet cassette plate 314 and the outlet cassette plate 320. In some embodiments, the cassette inlet 316 and the inlet conduit 322 are configured for fluid communication to accommodate fluid flow, such as in the axial direction. As such, the cassette inlet 316 can extend axially through the cassette assembly 310, including each inlet cassette plate 314 and each outlet cassette plate 320. Each cassette outlet 318 can be configured to be laterally and longitudinally aligned with each outlet conduit 324, which together form a portion of the outlet flow path 327 of the cassette assembly 310. The outlet flow path 327 extends axially through the cassette assembly 310, including the inlet cassette plate 314 and the outlet cassette plate 320.

The cassette assembly 310 has a first cassette plate 390 and a last cassette plate 392 (FIG. 12A). The first cassette plate 390 is the outer most inlet cassette plate 314 in the stack of cassettes. The last cassette plate 392 is the outer most outlet cassette plate 320 in the stack of cassettes. In embodiments where the cassette assembly 310 has a single cassette 312, the first cassette plate 390 is the inlet cassette plate 314 and the last cassette plate 392 is the outlet cassette plate 320. Notably, the outlet conduit 324 of the first cassette plate 390, which can be referred to as the first outlet conduit (FIG. 12C) defines an inactive volume of the outlet flow path 327. Particularly, fluid flow is directed from the separation layer of each of the cassettes 312 to the assembly outlet 310b via the outlet flow path 327, and the first outlet conduit is not positioned to receive such fluid flow (such as from a preceding cassette in the stack). Similarly, the inlet conduit 322 of the last cassette plate 392, which can be referred to as the last inlet conduit (FIG. 12B), defines an inactive volume of the inlet flow path 323 because the last inlet conduit is not positioned to direct fluid to a subsequent cassette. Such inactive volumes of the first outlet conduit and the last inlet conduit may negatively impact performance such as introducing unpredictability in fluid flow or collecting fluid that can become stagnant.

In various embodiments the cassette assembly 310 has an inlet plug 326 and an outlet plug 328. The inlet plug 326 can be configured to be inserted in the last inlet conduit to seal the last inlet conduit (as illustrated in FIG. 12B), such that fluid flow into the cassette assembly 310 inlet is directed through the cassettes 312. The inlet plug 326 can be configured to be removable and reinsertable in the last inlet conduit. The outlet plug 328 can be configured to be inserted in the first outlet conduit to seal the first outlet conduit, such that fluid flow from the cassettes is directed to the assembly outlet 310b. The outlet plug 328 can be configured to be removable and reinsertable in the first outlet conduit.

The inlet plug 326 may be inserted by pushing it into the last inlet conduit. Similarly, the outlet plug 328 may be inserted by pushing it into the first outlet conduit. Each plug 326, 328 may be constructed of a variety of different materials and combinations of materials. In some embodiments, the plugs 326, 328 are a plastic component. In other embodiments, one or both plugs 326, 328 are constructed of metal. In one example, the plugs 326, 328 are injection-molded, 3D printed or other material. The plugs 326, 328 can be constructed of, for example, a rubber, silicone, polyurethane, or other elastomeric material. In some embodiments the inlet plug 326 and the outlet plug 328 are constructed of the same material; in other embodiments the inlet plug 326 and the outlet plug 328 are constructed of different materials. The plugs 326, 328 are configured to frictionally engage the corresponding cassette plate 390, 392 that receives the plug. In some embodiments, the plugs sealably engage the corresponding cassette plate 390, 392 that receives the plug 326, 328. The plugs 326, 328 can be removable either by pulling them out of their respective paths 323, 327, or by pushing the plugs forward through the paths until they are pushed through their respective cassette plates 314, 320 and exit their respective flow paths 323, 327 from the opposite end from where they were inserted.

The inlet plug 326 and the outlet plug 328 can be configured as a solid cylindrical plug, in some embodiments. In other embodiments a plug 326, 328 can be threaded similar to the port plugs discussed above. In the latter example, the plugs 326, 328 can be removed and reinserted by twisting the plug 326, 328 relative to the cassette it is installed in. In alternative embodiments, the plugs 326, 328 can be configured as a snap-fit plug into their respective paths 323, 327, or can further alternatively be configured as a curable liquid which solidifies inside their respective paths 323, 327.

The plugs 326, 328 may each advantageously fill a corresponding inactive volume within the fluidically coupled pathways and cassettes. Such a configuration may advantageously prevent entry of fluid into the inactive volume during use, which may improve separation performance and maximize the volume of separated fluid. Further, in some embodiments, one or both of the plugs 326, 328 are completely received by their respective paths 323, 327 such that they do not extend outwardly from the cassette 312. Such a configuration may advantageously allow a relatively compact profile of the cassette assembly 310, and may also advantageously negate the need, for example, for an external device to close or plug the paths 323, 327.

The cassette assembly 310 can further include a first end plate 360 and a second end plate 362, as illustrated in FIGS. 11-12A. The first end plate 360 can be operatively couplable to an inlet cassette plate 314. Generally, the first end plate 360 is coupled to the first cassette plate 390 of the cassette assembly 310. The second end plate 362 can be operatively couplable to an outlet cassette plate 320 of a cassette 312. Generally, the second end plate 362 is coupled to the last cassette plate 392 of the cassette assembly 310. The end plates 360, 362 may advantageously provide rigidity and structure to the overall assembly 310 and may also advantageously provide a higher resistance to internal pressures resulting from use.

The first end plate 360 can include a first inlet port 364 (FIG. 12B). The first inlet port 364 can be configured to extend to the cassette inlet 316 of the first cassette plate 390. The first inlet port 364 is generally configured for fluid communication with the first cassette inlet 316. More particularly, the first inlet port 364 defines a fluid flow pathway that is configured to extend from an assembly inlet 310a to the first cassette inlet 316. The second end plate 362 can include the second outlet port 370 (FIG. 12C). The second outlet port 370 is generally configured for fluid communication with the last cassette outlet 318. The second outlet port 370 can be configured to extend from the last cassette outlet 318 to an assembly outlet 310b. More particularly, the second outlet port 370 defines a fluid flow pathway through which fluid exits from the last cassette outlet 318 of the assembly 310 through the assembly outlet 310b.

In various embodiments, the cassette inlet 316 and the cassette outlet 318 are in fluid communication via the separation layer 330 of the cassette 312. The separation layer 330 is disposed between the inlet cassette plate 314 and the outlet cassette plate 320. The separation layer 330 is generally configured to separate constituents in a fluid stream flowing from the cassette inlet 316 to the cassette outlet 318. The separation layer is configured to separate at least one component in the fluid stream from the fluid stream. Such separation may be realized through one or more of the following processes: chemical binding, binding of biological molecules, particle capture, absorption, adsorption, etc., as the fluid flows along and/or through the separation layer. The separation layer may include a single layer or a plurality of layers. The separation layer 330 is a fibrous mass in some embodiments. In some embodiments the separation layer 330 can be a particulate mass. The separation layer 330 is a single membrane in some embodiments. The separation layer 330 is a membrane stack in some embodiments. A membrane stack may include a plurality of membranes which are consecutively layered in the axial direction. The cassette inlet 316 can be configured to be in fluid communication with the cassette outlet 318 through the separation layer 330. The separation layer 330 can be consistent with separation layers discussed above with references to FIGS. 1-5.

As illustrated in FIG. 12A, each cassette can further include an inlet channel 336 and an outlet channel 338. The inlet channel 336 generally defines a path for fluid flow from the cassette inlet 316 (FIG. 12B) along a first lateral surface 334 (FIG. 12B) of the separation layer 330. The outlet channel 338 generally defines a path for fluid flow along a second lateral surface 335 (FIG. 12C) of the separation layer 330, which is opposite the first lateral surface 334. The outlet channel 338 extends from the separation layer 330 to the cassette outlet 318 (FIG. 12C).

The inlet channel 336 extends along an effective inlet surface area of the separation layer 330. The effective inlet surface area is partially defined by an effective length L4 (illustrated in FIG. 10). Conversely, the total length of the separation layer 330 is defined by L3. The difference between L3 and L4 may be a result of features obstructing fluid flow through portions of the surfaces separation layer, such as a separation layer seal 346 (discussed further herein) or structures defined by the cassette plates 314, 320. The inlet channel 336 can extend longitudinally from the cassette inlet 316 (e.g., along a length of the cassette). The inlet channel 336 can extend laterally from the cassette inlet 316 (e.g., along a width of the cassette). The inlet channel 336 can extend axially between the inlet cassette plate 314 and the effective inlet surface area 332a of the separation layer 330 (e.g., along a height of the cassette). In some embodiments, the inlet channel 336 can have an axial depth. The axial depth may, for example, help direct fluid flow, accommodate axial expansion of the separation layer 330 with a portion of the axial depth remaining clear of the separation layer 330 to accommodate fluid flow, etc. Axial expansion of the separation layer 330 may result from fluid flow through the separation layer 330. In embodiments with a membrane stack, for example, the inlet channel 336 can be sized depending on, for example, the number of membrane layers, the material of the membrane layers, the desired fluid flow rate through the assembly 310, etc.

The outlet channel 338 extends along an effective outlet surface area of the separation layer 330. The outlet channel 338 can extend longitudinally from the cassette outlet 318 (e.g., along a length of the cassette). The outlet channel 338 can extend laterally from the cassette outlet 318 (e.g., along a width of the cassette). The outlet channel 338 can extend axially between the outlet cassette plate 320 and the effective outlet surface area of the separation layer 330 (e.g., along a height of the cassette). In some embodiments, the outlet channel 338 can have an axial depth. The axial depth may, for example, help direct fluid flow, accommodate axial expansion of the separation layer 330 with a portion of the axial depth remaining clear of the separation layer 330 to accommodate fluid flow, etc. Axial expansion of the separation layer 330 may result from fluid flow through the separation layer 330. In embodiments with a membrane stack, for example, the outlet channel 338 can be sized depending on, for example, the number of membrane layers, the material of the membrane layers, the desired fluid flow rate through the assembly 310, etc.

In some embodiments, the inlet channel 336 can be defined by at least one of the inlet cassette plate 314, the separation layer 330, the effective inlet surface area, and the cassette inlet 316. The outlet channel 338 can be defined by at least one of the outlet cassette plate 320, the separation layer 330, the effective outlet surface area, and the cassette outlet 318. In some embodiments, the channels 336, 338 may be defined by any combination of the listed components, and additionally can be defined by one or more seals, discussed further herein.

Each cassette can further include a cassette inlet extension 317 (e.g., 317-1, 317-2) and a cassette outlet extension 325 (e.g., 325-1, 325-2), as illustrated in FIG. 12A. These extensions are configured to fluidically couple the inlet and cassette outlets to the inlet and outlet channels, respectively. The cassette inlet extension 317 can be defined by the inlet cassette plate 314. The cassette inlet extension 317 can be configured to fluidically couple the cassette inlet 316 and the inlet channel 336. The cassette inlet extension 317 can include a first portion 317-1 and a second portion 317-2. The first portion 317-1 can extend longitudinally from the cassette inlet 316 towards the inlet channel 336. In the current example, the second portion 317-2 extends axially from the first portion 317-1 to the inlet channel 336. The second portion 317-2 can be in fluid communication with the inlet channel 336 towards one longitudinal end of the inlet channel. In some embodiments, the second portion 317-2 can be in fluid communication with the inlet channel 336 at one longitudinal end of the inlet channel 336.

The cassette outlet extension 325 can be defined by the outlet cassette plate 320. The cassette outlet extension 325 can fluidically couple the cassette outlet 318 and the outlet channel 338. The cassette outlet extension 325 can include a first portion 325-1 and a second portion 325-2. The first portion 325-1 can extend axially from the outlet channel 338 to the second portion 325-2. The second portion 325-2 can extend longitudinally from the first portion 325-1 to the cassette outlet 318. The first portion 325-1 can be fluidically coupled to the outlet channel 338 towards the opposite end of the effective length L4 (illustrated in FIG. 10) of the separation layer 330 relative to the inlet extension first portion 317-1.

In alternative embodiments, the extensions do not define 90-degree segments relative to each other or the corresponding fluid flow path as shown and can instead define one or more curved segments. In further alternative embodiments, the inlet extension is a single segment that extends at an oblique angle from the cassette inlet 316 to the inlet channel 336 such that the inlet extension is not orthogonal to the cassette inlet 316 or the inlet channel 336. Similarly, the outlet extension 325 may define a single or multiple segments where at least one segment is curved. In some embodiments the outlet extension is a single segment that defines an oblique angle and extends from the outlet channel 338 to the cassette outlet 318 such that the outlet extension is not orthogonal to the cassette outlet 318 or the outlet channel 338.

The inlet cassette plate 314 and the outlet cassette plate 320 can be constructed of a variety of different materials and combinations of materials. In some embodiments, one or both of the cassette plates 314, 320 is plastic. In other embodiments, one or both of the cassette plates 314, 320 is metal. In one example, one or both of the cassette plates 314, 320 are injection-molded, 3D printed, machined, or combinations thereof. In some embodiments the inlet cassette plate 314 is constructed of the same material as the outlet cassette plate 320. In some other embodiments the inlet cassette plate 314 is constructed of a different material than the outlet cassette plate 320.

A channel spacer may be inserted into the inlet and/or outlet channels 336, 338 to ensure, for example, that the separation layer 330 does not expand into and block the channels. An example channel spacer is described above with reference to FIG. 6, which may apply to the current example. Each cassette 312 can include one or more channel spacers 140, 142 that are each configured to be received by the inlet channel 336 and/or the outlet channel 338. The inlet channel spacer 140 is generally configured to retain a minimum axial depth of the inlet channel 336 to maintain fluid flow along the inlet channel 336, consistently with discussions above.

Each cassette 312 can also include an outlet channel spacer 142 consistently with discussions above.

The spacer 140, 142 can be retained with friction and/or compression forces. Such friction forces can be among, for example, between the spacer 140, 142 and the separation layer 330, and between the spacer 140, 142 and the corresponding cassette plate 314, 320.

Similar to the discussions above, the ridges 144 may extend laterally along at least a portion of the channel width of the respective channel within which the spacer is positioned. The ridges have a width in the longitudinal direction, and a height in the axial direction. The ridges 144 may extend axially between the separation layer 330 and the adjacent cassette plate.

Each cassette 312 can further include a separation layer seal 346 (FIG. 12A). The separation layer seal 346 is generally configured to seal among the separation layer and each of the inlet cassette plate 314 and the outlet cassette plate 320 so that fluid does not escape from between the plates during use. The separation layer seal 346 can be installed between the inlet cassette plate 314 and the outlet cassette plate 320. In some embodiments, the separation layer seal 346 can be in contact with the inlet cassette plate 314 and the outlet cassette plate 320. The separation layer seal 346 can be configured to fluidically seal a perimeter region of the separation layer 330 (similar to that shown in FIG. 2), a perimeter region of the inlet channel 336, and a perimeter region (similar to that shown in FIG. 3) of the outlet channel 338. In some embodiments, the separation layer seal 346 is defined by a relatively tight coupling of the cassette plates 314, 320 that forms a liquid tight seal via compression forces around the separation layer 330. In such an example, a separation layer seal that is a separate component than the cassette plates 314, 320 can be omitted.

The separation layer seal 346 may be constructed of a variety of different materials and combinations of materials. In various embodiments the separation layer seal 346 can be constructed of an elastomeric material such as rubber, silicone, polyurethane, and the like. In some other embodiments, the separation layer seal 346 is a molded plastic. In yet other embodiments, the separation layer seal 346 is a metal. In one example, the separation layer seal 346 is injection-molded, 3D printed or formed through other types of processes. The separation layer seal 346 can include an overmolded gasket. The overmolded gasket can be injection molded around the perimeter of the separation layer 130 to form the separation layer seal 346.

In alternative embodiments, the separation layer seal can be more than one seal. The separation layer seal 346 can include a first o-ring inserted between the perimeter region on the first lateral surface 334 (such as the upstream surface) of the separation layer 330 and the inlet cassette plate 314. The separation layer seal 346 can include a second o-ring inserted between the perimeter region on a second lateral surface 335 (such as the downstream surface) of the separation layer 330 and the outlet cassette plate 320. In further alternative embodiments, the separation layer seal 346 may be a weld, for example, or an adhesive. A weld may be formed between, or an adhesive may be used to seal together, the cassette plates 314, 320, or the separation layer 330 and the inlet cassette plate 314, or the separation layer 330 and the outlet cassette plate 320, or any combination thereof.

Each cassette 312 can further include an attachment seal 358 (FIG. 12A). The attachment seal 358 is generally configured to fluidically seal between the inlet and outlet cassette plates 314, 320. The attachment seal 358 can be inserted between the inlet cassette plate 314 and the outlet cassette plate 320. The attachment seal 358 can extend laterally around and outside of a periphery of the separation layer 330. The attachment seal 358 can be positioned laterally between the axial surfaces of the inlet and outlet cassette plates 314, 320, respectively, and the separation layer seal 346. The attachment seal 358 can be constructed of a variety of different materials and combinations of materials consistent with those discussed above with reference to the separation layer seal. The attachment seal 358 may be retained with friction and/or compression forces, for example. Such forces can be among the attachment seal 358, the first cassette plate 314 and the second cassette plate 320.

In some embodiments, each inlet cassette plate 314 can define a first port 348 (particularly visible in FIG. 12B). The first port 348 can be configured to accommodate sampling fluid or removing gas once the cassette assembly 310 has been assembled, prior to use, or during use. The first port 348 can be in selective fluid communication with the cassette inlet 316. The first port 348 can laterally extend through an axial surface 315a (FIG. 11) of the inlet cassette plate 314. The first port 348 can extend laterally from the axial surface 315a to the cassette inlet 316. The first port 348 can be axially aligned with the cassette inlet extension 317. “Axially aligned” is used herein to mean that the first port 348 and the cassette inlet extension 317 (particularly the first portion 317-1) overlap in the axial direction. The first port 348 and the first portion 317-1 of the cassette inlet extension 317 can be configured for fluid communication to accommodate fluid flow, such as in the lateral direction. The cassette assembly 310 can further include a first port plug 349. The first port plug 349 can be configured to seal the first port 348. The first port plug 349 can be removable and reinsertable in the first port 348. In some embodiments the first port plug 349 is configured to be permanently sealably disposed in the first port 348.

The outlet cassette plate 320 can define a second port 350 in selective fluid communication with the cassette outlet 318. The second port 350 can laterally extend through an axial surface 315b (FIG. 11) of the outlet cassette plate 320. The cassette assembly 310 can further include a second port plug 351. The second port plug 351 can be configured to seal the second port 350. The second port plug 351 can be removable and reinsertable in the second port 350. In some embodiments the second port plug 351 is configured to be permanently sealably disposed in the second port 350.

The port plugs 349, 351 may be constructed of a variety of different materials and combinations of materials. In some embodiments, the port plugs 349, 351 are a molded plastic. In other embodiments, the port plugs 349, 351 are a metal. In one example, the port plugs 349, 351 are injection-molded, 3D printed or the like. The port plugs 349, 351 can be constructed using, for example, a rubber, silicone, polyurethane, or other elastomeric material. The port plugs 349, 351 can be constructed of a combination of materials such as a metal with a plastic and/or elastomeric coating. In some embodiments, the port plugs 349, 351 can be threaded and screwed into the ports 348, 350, as illustrated in FIGS. 12A-12C. The port plugs 349, 351 can define threads in such embodiments. The port plugs 349, 351 may each have a head 349a, 351a that mates with, for example, a mating feature of one or more tools such as a screwdriver or a wrench. The port plugs 349, 351 can be removable by unscrewing them from the ports 348, 350. In the current example visible in FIGS. 11-12C), the port plugs 349, 351 have hexagonal heads that align with, for example, a mating feature of a wrench for removal and reinsertion.

The cassette assembly 310 can further include a fastener 372 (FIG. 11). The fastener 372 is generally configured to retain the components of the cassette assembly 310 in an operative configuration. The fastener 372 can be configured to operatively couple the inlet cassette plate 314 and the outlet cassette plate 320. In embodiments with more than one cassette 312, the fastener 372 can operatively couple each of the cassette plates. In the current example, the fastener 372 includes a bolt. In some embodiments, the inlet cassette plate 314 can define a first axial through-hole (not currently visible). The outlet cassette plate 320 can define a second axial through-hole (not currently visible). The first axial through-hole and the second axial through-hole can be configured to laterally and longitudinally align with one another to receive the bolt. There may be more than one bolt, and respectively there may be more than one aligned through-hole to receive the more than one bolt.

In embodiments with the first end plate 360 and/or the second end plate 362, the fastener 372 can be configured to operatively couple the first end plate 360, the inlet cassette plate 314, the outlet cassette plate 320, and the second end plate 362. The first end plate 360 can define a third axial through-hole 380, and the second end plate 362 can define a fourth axial through-hole (not currently visible). Each of the first, second, third, and fourth axial through-holes can be configured to be laterally and longitudinally aligned with one another to receive the bolt. In some embodiments, at least one of the first, second, third, and fourth axial through-holes may include a threaded hole that is configured to engage the bolt.

In the examples consistent with the embodiment depicted in FIGS. 11-12C, the fasteners 372 are configured to engage the first end plate 360 and the second end plate 362. Such fasteners 372 do not directly engage any of the cassettes in the current example. The cassettes 312 are compressibly received by the end plates 360, 362. In particular, upon engagement of the fasteners 372, the end plates 360, 362 are configured to exert a compression force in the axial direction on the cassettes 312, which results in a relatively secured stack of cassettes 312.

In the particular example of FIGS. 11-12C, the cassette assembly 310 has fasteners 372 that include a plurality of bolts, where each bolt has a first nut 384 and a second nut 386. The first nut 384 can be configured to receive a first end of the bolt. The second nut 386 can be configured to receive an opposite, second end of the bolt. The first and second nuts 384, 386 can be configured to apply a compression force to the cassette assembly 310. The nuts 384, 386 can specifically apply the compression force to the operatively coupled end plates 360, 362 via the bolt. The first nut 384 can be in contact with the first end plate 360, and the second nut 386 can be in contact with the second end plate 362, or vice versa. Thus, the nuts 384, 386 can apply the compression force to the first and second end plates 360, 362. As a result, the end plates 360, 362 exert compression force on the stack of cassettes, which may advantageously seal each of the fluid flow path(s) through the cassette 312. In alternative embodiments, the fastener 372 may include various clamps, bolts, snap-fits, ties, etc., that can apply the compression force as described herein.

In further alternative embodiments, the fastener 372 may include at least one threaded bolt which threadably engages with the at least one threaded hole defined by at least one of the inlet cassette plate 314, the outlet cassette plate 320, the first end plate 360, and the second end plate 362. In embodiments with the at least one threaded bolt engaged with the at least one threaded hole, at least one of the first and second nuts 384, 386 may not be necessary. The at least one of the first and second nuts 384,386 may not be necessary because of the threaded engagement between the threaded bolt and the threaded hole.

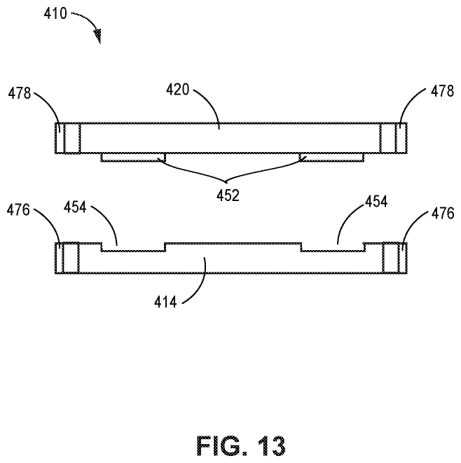

FIG. 13 is a schematic exploded view of some components of an alternate example cassette 410 consistent with the technology disclosed herein. The cassette 410 has an inlet cassette plate 414 and an outlet cassette plate 420. It will be understood that the components referenced in the description of FIG. 13 herein are consistent with the descriptions of the same components described elsewhere herein unless contradictory to the current description or corresponding figures.

The outlet cassette plate 420 can include an alignment feature 452. The inlet cassette plate 414 can include a mating alignment feature 454 that is configured to mate with the alignment feature 452 when the cassette plates 414, 420 are properly aligned and stacked. The alignment feature 452 is configured to be laterally and longitudinally aligned with the mating alignment feature 454. “Laterally and longitudinally aligned” is used herein to mean that the alignment and mating alignment features overlap in the lateral and longitudinal directions. The alignment feature 452 and the mating alignment feature 454 can assist in operatively coupling the outlet cassette plate 420 and the inlet cassette plate 414. The alignment feature 452 and the mating alignment feature 454 can advantageously guide a user to correctly stack the various cassette plates to assemble the cassette.

In some embodiments, the alignment feature 452 may include a protrusion and the mating alignment feature may include a receptacle that is configured to receive the protrusion, although the reverse configuration is also contemplated. In some alternative embodiments, the alignment feature 342 may form a snap-fit with the mating alignment feature 454. In other alternative embodiments, the alignment feature 452 may include a visual indicator such as a marking that is configured to align with the mating alignment feature 454, and vice versa. In some embodiments the mating alignment feature can be integral with one of the cassette plates 414, 420. In some other embodiments, the alignment feature can be a separate component (such as a pin, screw, or the like) that is mutually received by openings defined by the outlet cassette plate 420 and the inlet cassette plate 414. In embodiments with the first end plate 360 and/or the second end plate 362, the fastener can be configured to operatively couple the first end plate 360, the inlet cassette plate 314, the outlet cassette plate 320, and the second end plate 362. The first end plate 360 can define a third axial through-hole 380, and the second end plate 362 can define a fourth axial through-hole 382. Each of the first, second, third, and fourth axial through-holes can be configured to be laterally and longitudinally aligned with one another to receive the fastener.

In any embodiment described herein, a syringe, tube, or other implement can be used to introduce fluid to the cassette 110, 210, 312. Such implements may include mating components such as, for example, a luer lock, that is configured to sealably engage one or both of the assembly inlet 110a, 210a, 310a and the assembly outlet 110b, 210b, 310b. In alternative embodiments, the assembly inlet and the assembly outlet can be configured to mate with, for example, tubing of various sizes, syringes or needles, etc. In some embodiments, one or both of the inlets and outlets are configured to sealably couple to a standard sanitary connection interface such as a tri-clamp connection. In further alternative embodiments, the assembly inlet and the assembly outlet can be configured to be closeable or sealable and can be further configured to be reopened or unsealed.

### Tailored Flow Channels

The section entitled “tailored flow channels” may apply to any of the embodiments discussed above (cassettes 110, 210, 312). Any cassette as described herein may include tailored flow channels at one or both of the inlet channel and the outlet channel. The tailored flow channels may improve flow distribution of fluid introduced into the cassette compared to currently known cassettes. More specifically, fluid may evenly distribute through the inlet and outlet channels, and there may be a more even pressure drop for any volumetric flow rate of fluid through the cassette. Further, a pressure across the separation layer may advantageously have improved uniformity. Further, distributional or volumetric fluid flux across the separation layer may also have improved uniformity (as measured in average flux per unit area or as per unit of time). Thus, adsorption or elution of a target molecule adsorbed to the separation layer also has improved uniformity.

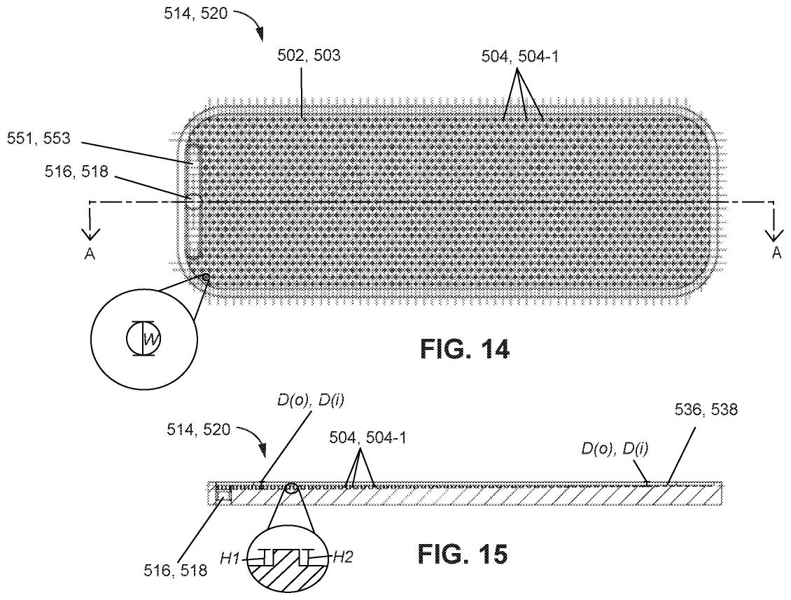

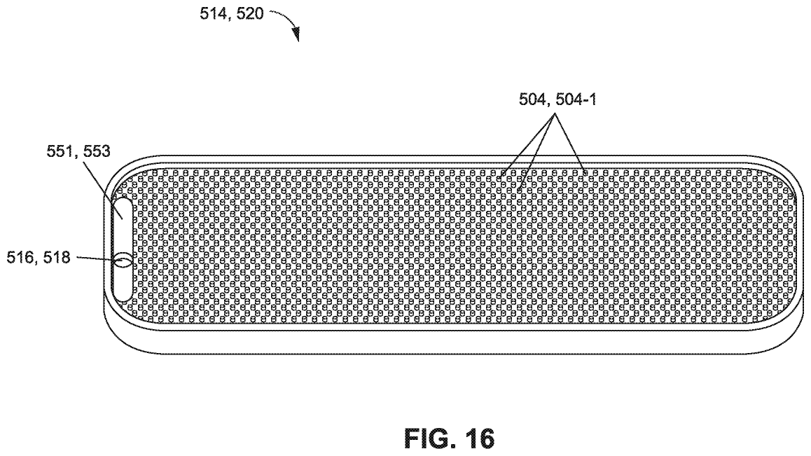

It will be understood the components referenced in the description of FIGS. 14-20 herein are consistent with the descriptions of the same components described elsewhere herein unless contradictory to the current description or corresponding figures. In one or more embodiments as described further herein, at least a portion of an inlet channel 536 (e.g., FIG. 15) is tapered. The inlet taper may be in the axial direction. In one or more embodiments as described further herein, and at least a portion of an outlet channel 538 (e.g., FIG. 15) is tapered. The outlet taper may be in the axial direction. Each of the inlet and outlet tapers may advantageously produce a more uniform fluid distribution through the cassette. A more uniform flow distribution through the cassette may advantageously provide better retention of a target molecule in the separation layer. Further, a more uniform flow distribution through the cassette may advantageously reduce the required amount of an elution fluid to wash through the cassette to retrieve the retained target molecule. Still further, a more uniform flow distribution through the cassette may advantageously provide a faster application, or use, of the cassette in various applications.

As illustrated in FIGS. 14-16, an inner surface 502 of an inlet cassette plate 514 may include, or define, at least one flow guide 504. The flow guide 504 may extend from the inner surface 502 into an inlet channel 536 (FIG. 15). A cassette inlet 516 can extend into an inlet distribution channel 551, which is in fluid communication with the inlet channel 536. The inlet distribution channel 551 can define an interface between the cassette inlet 516 and the inlet channel 536. The geometry of the inlet distribution channel 551 may be any shape which effectively allows fluid flow through the cassette (e.g., circular, ovate, square, rectangular, hexagonal, elongate slot, etc.). The geometry of the inlet distribution channel 551 may be configured to advantageously improve fluid flow uniformity across the entirety of the effective area of the separation layer (not shown). The inlet distribution channel 551 can define an elongate slot along the first width. The inlet distribution channel 551 can extend laterally along a width of an effective inlet surface area (the effective inlet surface area as described herein). Preliminary testing suggests that using an elongate slot geometry instead of a circular hole geometry in some implementations results in better flow distribution and flow uniformity across the entirety of the effective surface area of the separation layer, at least because an elongate slot provides better mixing of fluid, and lower pressures within the cassette. However, using a smaller geometry may advantageously result in less overall volume of fluid within the cassette.

As illustrated in FIG. 15, the inlet channel 536 may have an inlet channel depth, D(i), measured transverse to the effective inlet surface area of the separation layer (not shown, but the effective inlet surface area of the separation layer may be parallel to the outer surface of the cassette shown opposite the inlet channel 536). The inlet channel depth D(i) may be defined as the largest measured depth at any given cross-section taken laterally along line A-A. Thus, although there may be flow guides at any given cross-section taken laterally along line A-A, the inlet channel depth D(i) is measured without taking the flow guides into account.

The inlet channel depth D(i) may decrease as a distance from the cassette inlet 516 increases. In other words, moving left to right in FIG. 15, the inlet channel depth D(i) decreases. The decrease in the inlet channel depth D(i) may define a tapered inlet channel 536.

Similarly, FIGS. 14-16 may instead be considered to show an outlet cassette plate 520 instead of an inlet cassette plate 514. In such cases, an inner surface 503 of an outlet cassette plate 520 may include, or define, at least one flow guide 504. The flow guide 504 may extend from the inner surface into an outlet channel 538. A cassette outlet 518 can extend to an outlet distribution channel 553, which is in fluid communication with the outlet channel 538 (FIG. 15). The outlet distribution channel 553 can define an interface between the cassette outlet 518 and the outlet channel 538. The geometry of the outlet distribution channel 553 may be any shape which effectively allows fluid flow through the cassette (e.g., circular, ovate, square, rectangular, hexagonal, elongate slot, etc.). The geometry of the outlet distribution channel 553 may be configured to advantageously improve fluid flow uniformity across the entirety of the effective area of the separation layer (not shown). The outlet distribution channel 553 can define an elongate slot along the first width. The outlet distribution channel 553 can extend laterally along a width of an effective outlet surface area (the effective outlet surface area as described herein). Preliminary testing suggests that using an elongate slot geometry instead of a circular hole geometry in some implementations results in better flow distribution and flow uniformity across the entirety of the effective surface area of the separation layer, at least because an elongate slot provides better mixing of fluid, and lower pressures within the cassette. However, using a smaller geometry may advantageously result in less overall volume of fluid within the cassette.

As illustrated in FIG. 15, the outlet channel 538 may have an outlet channel depth, D(o), measured transverse to the effective outlet surface area of the separation layer (not shown, but the effective outlet surface area of the separation layer may be parallel to the outer surface of the cassette shown opposite the outlet channel). The outlet channel depth D(o) may be defined as the largest measured depth at any given cross-section taken laterally along line A-A. Thus, although there may be flow guides at any given cross-section taken laterally along line A-A, the outlet channel depth D(o) is measured without taking the flow guides 504 into account.

The outlet channel depth D(o) may decrease as a distance from the cassette outlet 518 increases. In other words, moving left to right in FIG. 15, the outlet channel depth D(o) decreases. The decrease in the outlet channel depth D(o) may define a tapered outlet channel. In some embodiments, the inlet channel depth D(i) and the outlet channel depth D(o) are identical but opposite to each other in the longitudinal direction.

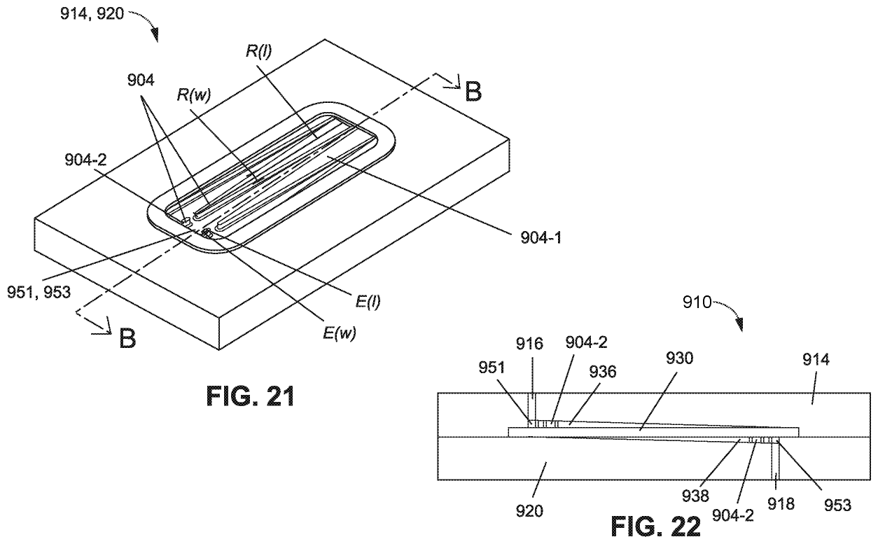

As described herein, each of the inlet and outlet cassettes may define a flow guide extending into the respective inlet and outlet channels such that the channel is tapered. The flow guide may include at least one of a screen, a rib (e.g., FIGS. 21-23), a pillar (e.g., FIGS. 14-20), a ramp, a singular flow guide or multiple flow guides, a permeable or non-permeable flow guide, etc.

As illustrated in FIGS. 14-16, the flow guide 504 (in either an inlet cassette plate 514 or an outlet cassette plate 520) may define a pillar 504-1. The pillar 504-1 may further define a cross-section parallel to the effective inlet surface area of the membrane stack when the cassette is assembled. The cross-section may define a shape including at least one of: a circle, a hexagon, a square, a rectangle, an oval, an octagon, a pentagon, a triangle, a diamond, a teardrop, a star, or any other shape. The cross-section of each pillar 504-1 may define a cross dimension, W (FIG. 14). The cross dimension W is the maximum measurement across the cross-section such as a diagonal or diameter measurement.

The pillar 504-1 may include a plurality of pillars 504-1 (FIGS. 14-20). Each of the plurality of pillars 504-1 may define a respective cross dimension W. In one or more embodiments, the cross dimension W of each of the plurality of pillars 504-1 may increase as a distance from the cassette inlet 516 (or a cassette outlet 518 with respect to the outlet cassette plate 520) increases. In one or more embodiments, a height of each of the plurality of pillars 504-1 decreases as a distance from the inlet and/or outlet 516, 518 increases. “Height” may be measured in the axial direction, which may or may not be in a vertical orientation. Due to the taper, each of the plurality of pillars 504-1 has a first height, H1 (FIG. 15), closer to the cassette inlet and/or outlet 516, 518 and has a second height, H2 (FIG. 15), farther from the cassette inlet and/or outlet 516, 518 than the first height H1. Thus, H2 may be equal to or less than H1 for an individual pillar 504-1. Further, the first height of each of the plurality of pillars 504-1 may decrease as a distance from the cassette inlet and/or outlet 516, 518 increases, and the second height of each of the plurality of pillars 504-1 may decrease as a distance from the cassette inlet and/or outlet 516, 518 increases.

The plurality of pillars 504-1 may define a density of pillars 504-1. The density of pillars 504-1 may be measured in various ways. For example, the density of pillars 504-1 may be measured in a plane taken lateral to line A-A (e.g., as a percentage or ratio of pillars 504-1 relative to inlet or outlet channel 536, 538, where each are measured as a distance along the lateral plane). Further, for example, the density of pillars 504-1 may be measured as a percentage or ratio of the surface area of pillars 504-1 relative to the surface area of the inlet or outlet channel 536, 538 in a section of the inlet cassette plate 514. The section of the cassette used to measure density may include half of the effective length L4 or less, and may include the entirety of the effective width W4 or less (effective length and width discussed herein with respect to FIGS. 5 and 10).

In one or more embodiments, the density of the plurality of pillars 504-1 may increase as a distance from the cassette inlet 516 increases. In one or more embodiments, the density of the plurality of pillars 504-1 may increase as a distance from the cassette outlet increases. As the density of the plurality of pillars 504-1 increases, the pressure of any fluid in the respective channel increases since there is more resistance to fluid flow. Thus, advantageously, the fluid flow is directed towards the separation layer (not shown) in a uniform matter. As fluid enters the cassette, the pressure is high due to the injection force of the fluid. The pressure decreases as the fluid moves away from the injection point, which can be attributed to flow resistance and decreased volumetric flow rate as fluid flows through the separation layer and into the outlet channel. To offset the drop in pressure, the increase in flow guide density reduces the volume of the flow channels, which helps increase pressure so that pressure along the separation layer is more evenly distributed.

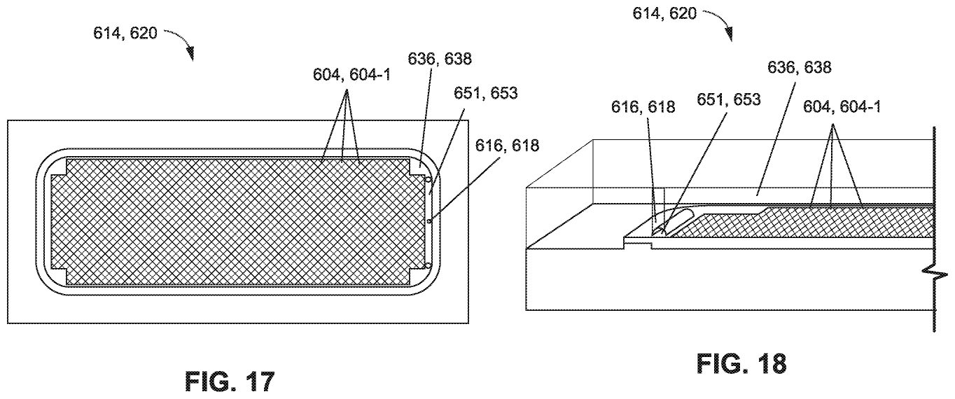

It will be understood the components referenced in the description of FIGS. 17-18 herein are consistent with the descriptions of the same components described elsewhere herein unless contradictory to the current description or corresponding figures. As illustrated in FIGS. 17-18, the flow guide 604 includes a plurality of pillars 604-1. The plurality of pillars 604-1 may not be evenly distributed throughout an inlet or outlet cassette plate 614, 620, and instead may be distributed in a pattern. For example, the four corners of the inlet or outlet channel 636, 638 may not include any pillars 604-1. The lack of pillars may advantageously shift the concentration of the internal pressure near and away from the inlet or cassette outlets 616, 618 and the inlet or outlet distribution channels 651, 653. The distribution of the pillars 604-1 may be placed in any pattern (e.g., symmetrical, asymmetrical) within the cassette. The shape, including the cross dimension W, and the height or depth of each individual pillar 604-1 may be the same or different from any or all of other pillars of the plurality of pillars 604-1.

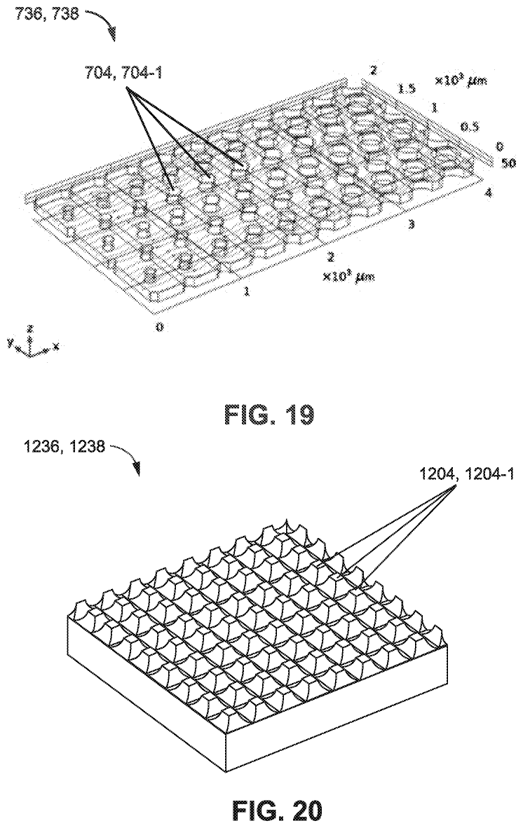

It will be understood the components referenced in the description of FIG. 19 herein are consistent with the descriptions of the same components described elsewhere herein unless contradictory to the current description or corresponding figures. FIG. 19 demonstrates fluid flow through a tapered inlet or outlet channel 736, 738 and around a plurality of pillars 704-1. As the plurality of pillars 704-1 increases in surface area and density, the internal fluid pressure rises. The increased fluid pressure may be advantageous, as described herein.

It will be understood the components referenced in the description of FIG. 20 herein are consistent with the descriptions of the same components described elsewhere herein unless contradictory to the current description or corresponding figures. FIG. 20 demonstrates a plurality of pillars 1204-1 in an inlet or outlet channel 1236, 1238. The plurality of pillars 1204-1 may define a square cross-sectional shape. The plurality of pillars 1204-1 may be manufactured using a machining process, for example, which may advantageously save time and money during the manufacturing process.

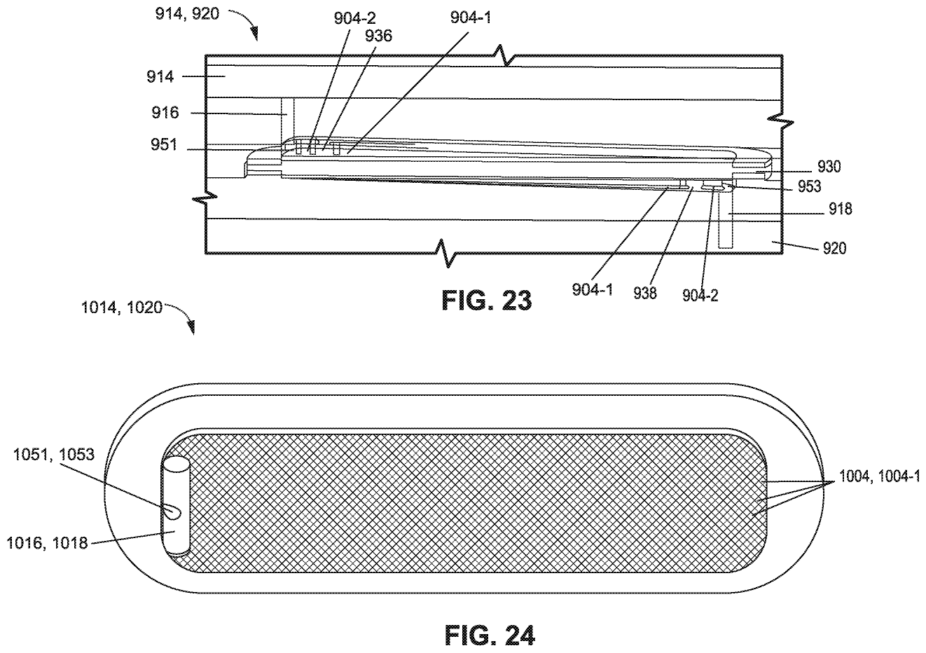

It will be understood the components referenced in the description of FIGS. 21-23 herein are consistent with the descriptions of the same components described elsewhere herein unless contradictory to the current description or corresponding figures. FIG. 21 is a perspective view of an example cassette plate 914, 920 which can be an inlet cassette plate or an outlet cassette plate. FIG. 22 is an example cross-sectional view of an example cassette consistent with FIG. 21, and FIG. 23 is a perspective cross-sectional view of the example cassette. The cassette 910 has an inlet channel 936 and an outlet channel 938. A separation layer 930 is disposed between the inlet cassette plate 914 and the outlet cassette plate 920. The inlet cassette plate 914 has an inlet distribution channel 951 and the outlet cassette plate 920 has an outlet distribution channel 953. As illustrated in FIGS. 21-23, a flow guide 904 (in either an inlet cassette plate 914 or an outlet cassette plate 920) may define a rib 904-1. The rib 904-1 may further define a rib length, R(l), and a rib width, R(w), as illustrated in FIG. 21. The rib width R(w) may increase as a distance from the cassette inlet or cassette outlet 916, 918 increases. Increasing the rib width results in a higher internal pressure on the fluid flow, which may advantageously result in more uniform fluid flow as described herein. In alternative embodiments, a rib depth (not shown) may be varied, the distance between ribs may be varied, the ribs may not consist of straight lines, the ribs may include sharp corners instead of rounded, etc., in order to advantageously adjust the flow distribution.

The flow guide 904 may further include a rib extension 904-2 as illustrated in FIG. 21. The rib extension 904-2 may define an extension length E(l) and an extension width E(w). The rib extension 904-2 may be shaped and sized to optimize the internal fluid pressure near inlet or cassette outlets 916, 918 and inlet or outlet distribution channels 951, 953. The rib extension 904-2 may define any cross-sectional shape and dimension, but is generally smaller than the rib 904-1 since it is localized to the inlet or outlet distribution channels 951, 953.

FIG. 24 is a perspective view of an inlet cassette plate or outlet cassette plate 1014, 1020 having a cassette inlet or cassette outlet 1016, 1018 and an inlet distribution channels or outlet distribution channels 1051, 1053 consistent with various examples. In this embodiment, the cassette plate may include an embossed pattern 1004-1 that creates a flow guide 1004. The embossed pattern 1004-1 may extend across the cassette similar to the pillars 604-1 described above with reference to FIGS. 17 and 18. The embossed pattern 1004-1 may define a height that increases as a distance from the inlet or outlet distribution channels 1051, 1053 increases. As illustrated in FIG. 24, the embossed pattern 1004-1 is in a grid pattern, but the embossed pattern 1004-1 may define any shape or pattern (e.g., symmetrical, asymmetrical).

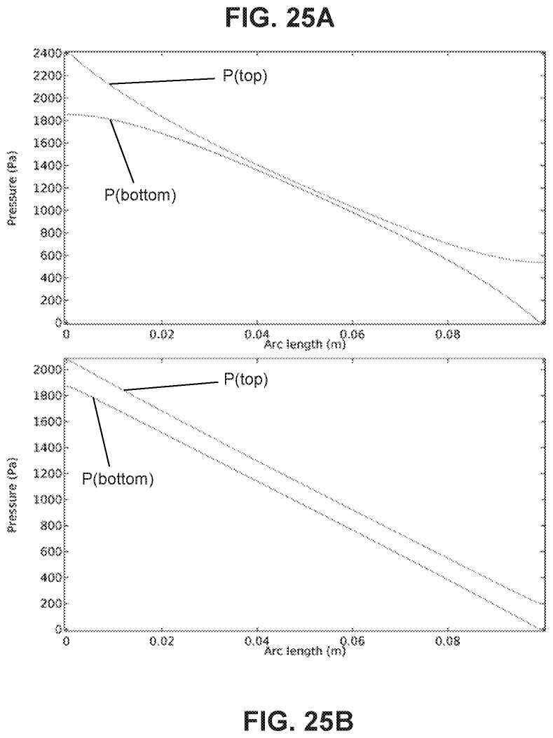

FIGS. 25A and 25B are example data illustrating pressure differential across the separation layer for different cassettes at various arc lengths (i.e., positions) along the length of the inlet channel of an inlet cassette plate (“P (top)”) and along the length of an outlet channel of an outlet cassette plate (“P (bottom)”).

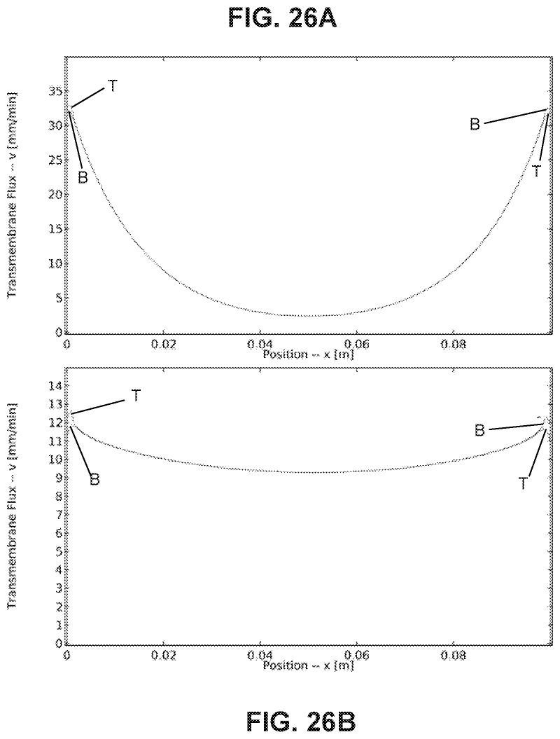

FIGS. 26A and 26B are example data illustrating transmembrane flux at various positions along the channels of the inlet cassette plate (“T”) and the outlet cassette plate (“B”) of the cassettes of FIG. 25A and FIG. 25B, respectively.

As shown in FIG. 25A, which illustrates a conventional cassette, there is a larger pressure difference across the separation layer, between the inlet channel and outlet channel, at each end of the cassette plate, and a lower pressure difference in the middle of the cassette plate. A lower pressure difference may create a “dead spot” where fluid is not “pushed” through the separation layer. Thus, as shown in FIG. 26A, the transmembrane flux (hereinafter “flux”) is much lower in the center position than at each end of relevant channels. Conversely, FIG. 25B illustrates more uniform pressure difference at all positions along the inlet and outlet channels consistent with cassette plates as described herein, which results in a more uniform flux, as illustrated by FIG. 26B.

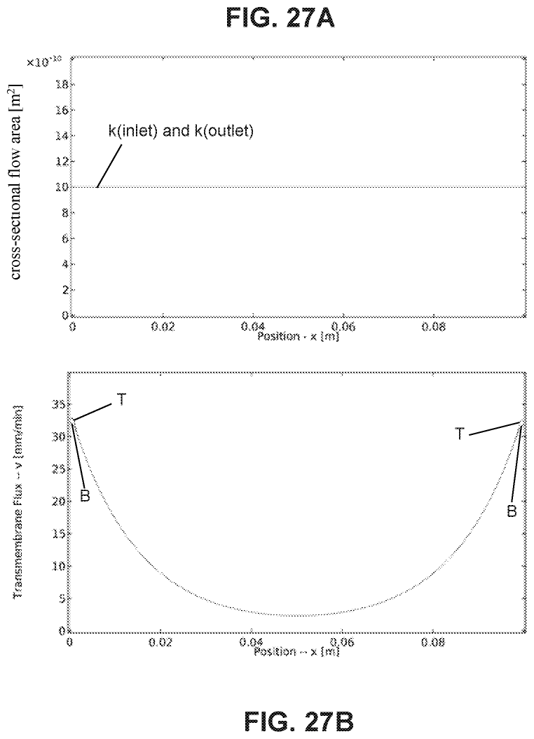

FIG. 27A is example data illustrating a constant cross-sectional flow area at various positions along the length of the inlet and outlet channel of the inlet cassette plate (“k(inlet)”) and the outlet cassette plate (“k(outlet)”), respectively, for a conventional cassette design. The cross-sectional area may be defined by the inlet cassette plate/outlet cassette plate itself, and additionally other structures that may limit or define the cross-sectional flow area such as media disposed within the channel, etc. FIG. 27B is example data illustrating the transmembrane flux along the length of the channels (“T” represents the inlet channel and “B” represents the outlet channel) for the conventional cassette design of FIG. 27A. The flux is much lower in the center position than at each end of relevant channels, indicating “dead spots” as discussed herein.

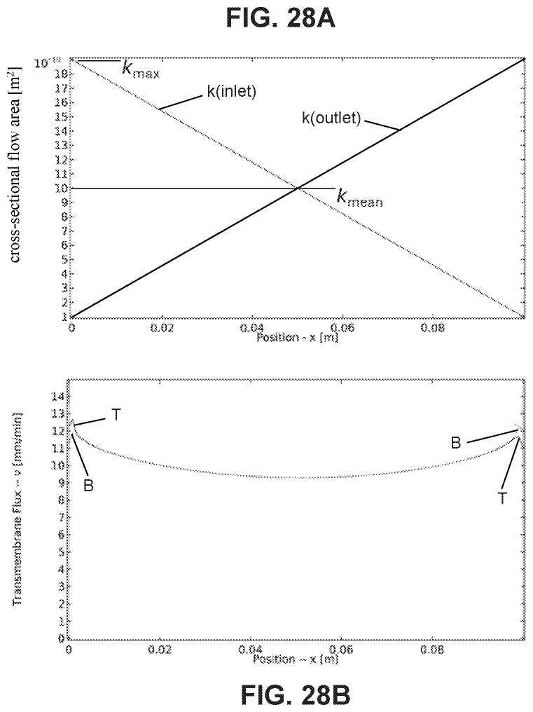

FIGS. 28A and 28B are example comparative data, in contrast to FIGS. 27A and 27B, illustrating varying cross-sectional flow area of the inlet and outlet channels and the corresponding transmembrane flux at along the length of each of the channels (inlet channel, “T,” and outlet channel, “B”). For example, FIG. 27A illustrates uniform cross-sectional flow area as seen in conventional cassettes, whereas FIG. 28A illustrates non-uniform cross-sectional flow area, specifically where the inlet channel cross-sectional flow area decreases linearly from the cassette inlet along the length of the inlet channel, and outlet channel cross-sectional flow area decreases linearly from the cassette outlet along the length of the outlet channel. It is noted that in this example, the linear change in the cross-sectional flow area of the inlet channel and the outlet channel are of equal magnitude but are in opposite directions. Notably, the flux shown in FIG. 28B is more uniform compared to FIG. 27B. Non-uniform cross-sectional flow area along the length of the channel of FIG. 28A thus results in a more uniform flux across the cassette plate and shows an improvement over conventional cassette plates.

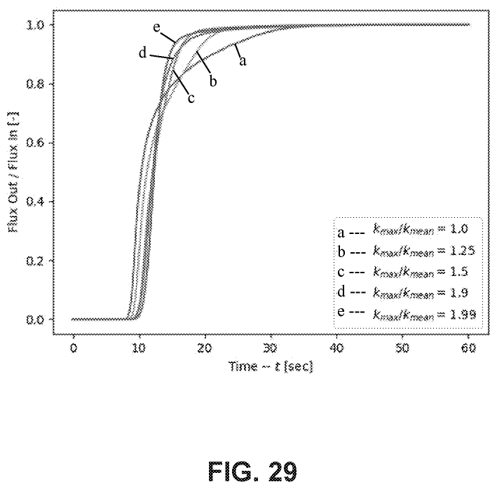

FIG. 29 illustrates salt breakthrough for different ratios (a, b, c, d, and e) of maximum cross-sectional flow area (“kₘₐₓ”) over mean cross-sectional flow area (“kₘₑₐₙ”) graphed over time, where the separation layer of a cassette is used to separate salt from a fluid flowing through the cassette. Salt breakthrough is defined as when salt molecules or particles flow out of the cassette instead of being trapped in the separation layer. The salt breakthrough is expressed as the ratio of the salt exiting the cassette (“fluxₒᵤₜ”) relative to the salt entering the cassette (“fluxᵢₙ”), and thus at a ratio of 1, it is expected that the separation layer no longer has capacity retain the salt. In general, if the graphed line has sharper corners (e.g., ratio e), it represents a higher resolution separation than a line that is more gently curved (e.g., ratio a). A higher resolution separation may indicate more efficient separation of molecules by the separation layer, which may be indicative of more even fluid flow through the surface area of the separation layer. Thus, the cassette may, more quickly and more accurately, achieve the resolution separation desired for a particular application or procedure. Thus, as shown in FIG. 29, a higher ratio of maximum cross-sectional flow area over mean cross-sectional flow area is more ideal. Further, more variation in cross-sectional flow area may result in a sharper corner.

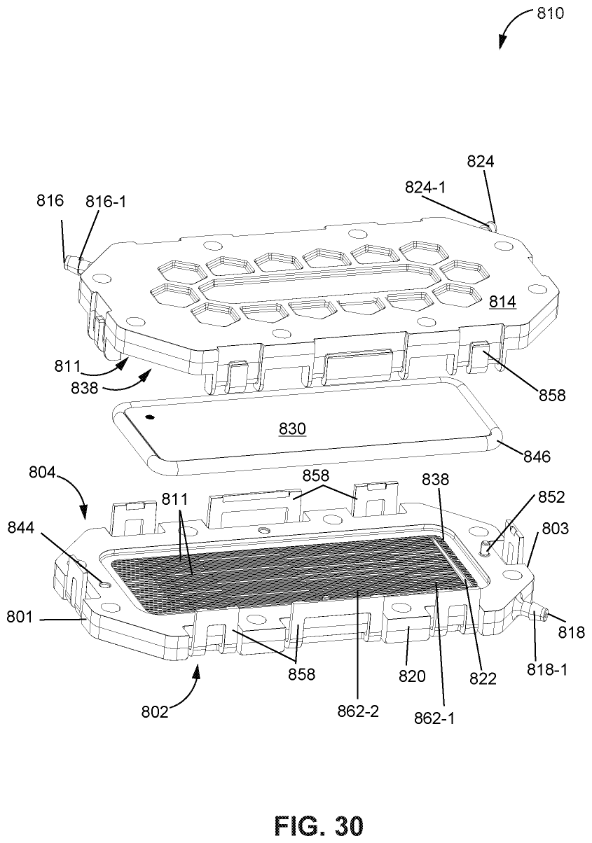

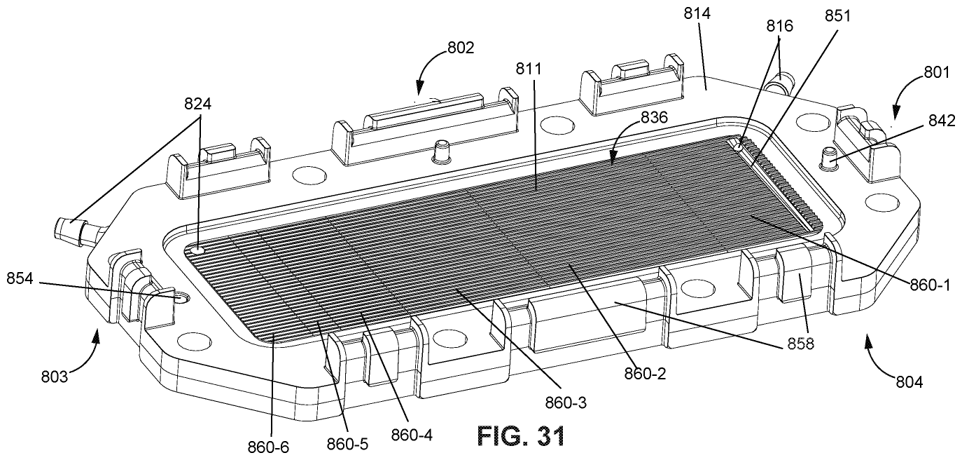

Cassettes consistent with the technology disclosed herein can have a variety of different configurations. FIG. 30 depicts an exploded perspective view of another example cassette 810 consistent with the technology disclosed herein. The cassette 810 is generally configured to receive a fluid flow therethrough. The cassette 810 generally has an inlet cassette plate 814, an outlet cassette plate 820, and a separation layer 830. FIG. 31 is another perspective view of the inlet cassette plate from a second perspective to show features that may not be visible in FIG. 30. It will be understood the components and features referenced in the description of FIGS. 30-31 herein are consistent with the descriptions of the same components and features described elsewhere herein unless contradictory to the current description or corresponding figures.

Similar to other embodiments described herein, the separation layer 830 is disposed between the inlet cassette plate 814 and the outlet cassette plate 820. The outlet cassette plate 820 can be configured to be arranged in a stack with the inlet cassette plate 814. The inlet cassette plate 814 can define a cassette inlet 816. The cassette inlet 816 defines a path for inlet fluid flow into the cassette 810. The cassette inlet 816 can extend longitudinally through the inlet cassette plate 814 (e.g., along a length of the cassette plate). The cassette inlet 816 can extend laterally through the inlet cassette plate 814. In the current example, the cassette inlet 816 extends diagonally relative to the longitudinal and lateral directions (FIG. 31). The cassette inlet 816 can be positioned towards a first longitudinal end 801. The cassette inlet 816 can be positioned towards a first lateral end 802.

The outlet cassette plate 820 of the cassette 810 defines a cassette outlet 818. The cassette outlet 818 can extend longitudinally through the outlet cassette plate 820. The cassette outlet 818 can extend laterally through the outlet cassette plate 820. In the current example, the cassette outlet 818 extends diagonally relative to the longitudinal and lateral directions (FIG. 30). The cassette outlet 818 can be positioned towards a second lateral end 804 of the cassette. The cassette outlet 818 can be positioned towards the second longitudinal end 803 of the cassette. The cassette inlet 816 can be generally configured for fluid communication with the cassette outlet 818.

In various embodiments, the cassette inlet 816 and the cassette outlet 818 are in fluid communication via the separation layer 830 of the cassette 810. The separation layer 830 is disposed between the inlet cassette plate 814 and the outlet cassette plate 820. The separation layer 830 can extend from the first longitudinal end 801 to the second longitudinal end 803. The separation layer 830 can define a total inlet surface area and a total outlet surface area. The separation layer 830 can be consistent with separation layers discussed above, such as a separation layer that is a membrane stack.

Preliminary testing suggests that placing the inlet and outlet openings longitudinally and laterally across from each other towards each end (801, 803) of the cassette may advantageously result in improved flow distribution and flow uniformity across the entirety of the effective surface area of the separation layer 830. In particular, the longitudinal separation of the inlet and outlet promotes flow distribution in the longitudinal direction. The lateral separation of the inlet and outlet promotes flow distribution in the lateral direction.

### Inlet/Outlet Channels

The cassette 810 generally defines an inlet channel 836 and an outlet channel 838. The inlet channel 836 generally defines a path for fluid flow from the cassette inlet 816 along a first surface of the separation layer 830. The inlet channel 836 can define an effective inlet surface area of the separation layer 830 as discussed in detail above. The outlet channel 838 generally defines a path for fluid flow along a second surface of the separation layer 830, which is opposite the first surface. The outlet channel 838 is positioned in the axial direction between the separation layer 830 and the outlet cassette plate 820.

In the current examples, the inlet channel 836 extends longitudinally from the cassette inlet 816. The inlet channel 836 can extend laterally from the cassette inlet 816. The inlet channel 836 is positioned axially between the inlet cassette plate 814 and the effective inlet surface area of the separation layer 830. The inlet channel 836 defines an inlet channel depth in the axial direction. The outlet channel 838 can extend longitudinally from the cassette outlet 818. The outlet channel 838 can extend laterally from the cassette outlet 818. The outlet channel 838 can define an effective outlet surface area of the separation layer 830 as discussed in detail above. Similar to the inlet channel, the outlet channel 838 defines an outlet channel depth in the axial direction.

### Inlet Distribution Channel

In one or more embodiments, the inlet cassette plate 814 may define an inlet distribution channel 851 (FIG. 31) extending laterally from the cassette inlet 816. The cross-sectional area of the inlet distribution channel 851 may narrow along its lateral extension from the cassette inlet. For example, the inlet distribution channel 851 may narrow in the longitudinal direction and/or in the axial direction as the inlet distribution channel 851 extends laterally across the width of the cassette. The cross-sectional flow area of the inlet distribution channel 851 is thus decreased to maintain fluid velocity along the length and width of the inlet channel.

### Outlet Distribution Channel

In one or more embodiments, the outlet cassette plate 820 may define an outlet distribution channel 822 (FIG. 30) extending laterally from the cassette outlet 818. Similar to the inlet distribution channel 851, the outlet distribution channel 822 may extend across a width of the outlet cassette. The cross-sectional area of the outlet distribution channel 822 may narrow along its lateral extension from the cassette outlet 818. For example, the outlet distribution channel 822 may narrow in the longitudinal direction and/or in the axial direction as the outlet distribution channel extends laterally across the width of the cassette. The cross-sectional flow area of the outlet distribution channel is thus decreased to maintain fluid velocity along the length and width of the outlet channel.

### Channel Taper

Similar to the inlet and outlet distribution channels (851, 822), the inlet and outlet channels (836, 838) themselves may define a flow area that decreases as a longitudinal distance from the corresponding inlet/outlet increases. For example, the inlet channel depth may decrease as a longitudinal distance from the cassette inlet 816 increases. As another example, the outlet channel depth may decrease as a longitudinal distance from the cassette outlet 818 increases.

The inlet channel 836 may define an inlet slope in the longitudinal direction. The inlet slope changes the cross-sectional flow area through the inlet channel 836 in the longitudinal direction. The word “slope” is used herein to refer to an oblique angle relative to a reference non-inclined plane, such as a horizontal or vertical plane, where a larger slope defines an angle of greater magnitude from the reference non-inclined plane compared to a smaller slope. In one or more embodiments, the inlet channel depth may decrease towards the cassette outlet 818. In one or more embodiments, the inlet slope may remain constant along a portion of the length of the inlet channel 836, or along the entire length of the inlet channel 836 (an example of which is discussed above with respect to the discussion of FIG. 28A). In one or more embodiments, the inlet slope may increase towards the cassette outlet 818 such that the inlet slope is larger towards the cassette outlet 818 than the inlet slop towards the cassette inlet 816. In some such embodiments, the inlet slope may increase continuously along at least a portion of the length of the channel. In some other such embodiments the inlet slope may increase incrementally along at least a portion of the length of the channel.

In some implementations, the inlet slope configuration may achieve a more uniform pressure drop, and ultimately a more uniform fluid flow through the separation layer 830, compared to configurations where the inlet channel 836 does not have a slope. As fluid enters the cassette 810, some of that fluid will start to flow through the separation layer 830, and as the remaining fluid flows along the length of cassette 810, more fluid flows through the separation layer 830 such that the volumetric flow of the fluid in the inlet channel decreases along the length of the inlet channel 836. To promote consistent fluid velocity, the inlet channel depth decreases to reduce the area through which fluid may flow. In alternative embodiments, the inlet slope may be zero and the inlet channel 836 may define a constant depth that does not taper, and consistent fluid velocity may be achieved via other means that are discussed herein.

Similarly, the outlet channel 838 may define an outlet slope in the longitudinal direction. The outlet slope similarly changes the cross-sectional flow area through the outlet channel 838 in the longitudinal direction. In one or more embodiments, the outlet channel depth may decrease towards the cassette inlet 816. In one or more embodiments, the outlet slope may remain constant along a portion of the length of the outlet channel 838, or along the entire length of the outlet channel 838. In one or more embodiments, the outlet slope may increase towards the cassette inlet 816 such that the outlet slope is larger towards the cassette inlet 816 than the outlet slope towards the cassette outlet 818. The outlet slope may have the same configurations and potential advantages discussed above with reference to the inlet slope. In alternative embodiments, the outlet slope may be zero and the outlet channel 838 may define a constant depth that does not taper, and consistent fluid velocity may be achieved via other means as discussed herein. In some embodiments, the inlet slope and the outlet slope are identical but opposite to each other in the longitudinal direction.

In one or more embodiments, the slope of the inlet and outlet channel may be approximated by a cubic root equation as described further herein.

In particular, in order to achieve uniform flow across the separation layer, there must be a uniform pressure drop across the separation layer. Further, if there is uniform fluid flow through the separation layer, the flow rate through the separation layer at a first end of the inlet/outlet channel (at the cassette inlet/outlet, respectively) is expected to be a maximum, and the flow rate through the separation layer at the opposite, second end of the inlet/outlet channel (towards the cassette outlet/inlet, respectively) is expected to be a minimum, or zero. The first end of the inlet channel is opposite the first end of the outlet channel when the inlet and outlet are located at opposite ends of the cassette. The flow rate through the separation layer changes linearly from the first end to the second end of the inlet/outlet channel, consistently with the equation below:

$$Q ( x ) = {Q}_{0} ( 1 - \frac{x}{L} ) ,$$

where Q(x) is the volumetric flow rate in the channel in the longitudinal direction at longitudinal position x along the length of the channel. Q₀ is the maximum volumetric flow rate through the channel (at the inlet/outlet in the case of the inlet/outlet channels, respectively). L is the length of the channel and x is the longitudinal location along the length of the channel.

Because pressure drop is proportional to velocity, the pressure drop is a maximum on the first end of the inlet/outlet channel and zero on the second end of the inlet/outlet channel, and the pressure drop also changes linearly from the first end to the second end of the inlet/outlet channel. Thus dP/dx, which is the change in pressure along the longitudinal length of the inlet/outlet channel, is expected to be constant.

The equation below is Darcy's Law, which dictates that pressure drop is proportional to velocity. Variable k(x) is the permeability of the inlet/outlet channel at longitudinal position x. Variable A(x) is the cross-sectional area of the inlet/outlet channel at longitudinal position x. Variable u is fluid viscosity.

$$Q ( x ) = - \frac{k ( x ) A ( x )}{μ} \frac{dP}{dx} .$$

The following equation relates the permeability of the inlet/outlet channel at the longitudinal position x (k(x)) to the height of the inlet/outlet channel at longitudinal position x, (b(x)), which is derived from Hagen-Poiseuille Flow for parallel plates:

$$k ( x ) = \frac{1}{12} {b ( x )}^{2} .$$

The cross-sectional area A(x) of the inlet/outlet channel at the longitudinal position x is based on multiplying b(x), which is the inlet/outlet channel height at the longitudinal position x by w, which is the inlet/outlet channel width at the longitudinal position x.

The variables and equations listed above were input into the Darcy's Law equation, which, after simplification, led to the following equation:

$$\frac{dP}{dx} = \frac{12 μ}{w} \times \frac{{Q}_{0} ( 1 - \frac{X}{L} )}{{b ( x )}^{3}} .$$

Since μ, w, Q₀, may be constant, to achieve a dP/dx that remains constant, the inlet/outlet channel height b(x) must cancel out the variables that are not constant from the above equation, in particular, 1−(x/L). Furthermore, the inlet/outlet channel height b(x) is proportional to the initial inlet/outlet channel height at x=0, which is also the maximum height of the inlet/outlet channel, b₀, and which is also constant.

Theoretically, each of the inlet and outlet channels has a first end and a second end as discussed herein. Further, to calculate an inlet/outlet channel height at any location along the inlet/outlet channel length, a mathematical equation may input the height at both of the first and second ends and use either a linear or a non-linear relationship to calculate the inlet/outlet channel height at any location along the length of the inlet/outlet channel. However, a linear relationship likely would not apply to the equation since the velocity of fluid through the inlet/outlet channel would not be linear along the length of the inlet/outlet channel. Thus, the generic form of the tapered spacer gap, or the equation to calculate the channel height along the length of the channel, is the following, and is non-linear with an unknown exponent:

$$b ( x ) = {b}_{0} {( 1 - \frac{x}{L} )}^{n} .$$

The exponent n may be varied to determine its effect on the pressure distributions. For n=0, there is no taper and the gap has a uniform value b₀. For n=1, the gap has a linear profile. Varying the value of this exponent n may help to determine whether pressure distributions on either side of the separation layer are “parallel” (dP/dx equivalent).

When the channel height b(x) equation is used in the simplified Darcy's Law equation confirms that dP/dx is constant along the longitudinal length of the channel:

$$\frac{dP}{dx} = \frac{12 μ}{w} \times \frac{{Q}_{0}}{{b}_{0}} .$$

An exponent of n=1/3 (shown below) gives pressure profiles that are nearly linear over most of the length of the membrane (as shown, for example, in FIG. 25B). However, it appears that the slope of the pressure profile on the low-pressure side (“P(bottom)”) may be steeper compared to that on the high-pressure side (“P(top)”). Comparatively, for n=1/4, the slope on the high-pressure side may be steeper compared to that on the low-pressure side. This suggests that the more accurate exponent n is somewhere between n=1/4 and n=1/3, in order to result in equal slopes of the pressure profiles and thus result in more uniform flux. However, given that the theory above predicts n=1/3, it is likely that this value of n will depend on the system parameters (e.g. L, Q₀).

In conclusion, numerical simulations of a two-dimensional system support the analysis that a channel with a tapered height given by the below equation gives pressure profiles on either side of the separation layer that are approximately parallel, and will therefore produce approximately uniform transmembrane flux.

$$b ( x ) = {b}_{0} {( 1 - \frac{x}{L} )}^{1 / 3} .$$

FIG. 35 is a graph depicting the depth (or height) of an example cubic root channel where the total channel length is 100 mm and the initial channel height b₀ is 0.67 mm. In some embodiments consistent with the technology disclosed herein, where the channel width (whether the inlet channel or outlet channel) remains constant, the channel height is approximated by the cubic root channel height b(x) equation above, which will be described in more detail below. Notably, consistently with the channel height equation above, the volume of the channel is generally 75% of what it would be if the channel cross sectional flow area of the channel were not tapered. In some embodiments consistent with the technology disclosed herein, the cross-sectional flow area of the inlet/outlet channel is tapered such that the volume of the channel is 60-80% compared to a flow channel that is not tapered from the inlet/outlet to the outlet/inlet (respectively).

It will be appreciated that, in some other embodiments, the inlet channel and/or the outlet channel height may remain constant and the inlet channel and/or outlet channel may define a width, respectively, that tapers (e.g., increases and/or decreases) along the longitudinal length of the channel. In such other embodiments, the cross sectional flow area tapers in the longitudinal direction. The above equations may not apply to such other embodiments with a tapered width.

In one or more embodiments, the inlet and outlet slopes may change incrementally across the longitudinal length of the channel. For example, a first length 860-1 of the inlet channel 836 extending from the inlet distribution channel 851 may have a first slope. A second length 860-2 of the inlet channel 836 extending from the first length 860-1 may have a second slope. The second slope may be greater than the first slope. A third length 860-3 of the inlet channel 836 extending from the second length 860-2 may have a third slope. The third slope may be greater than the second slope. A fourth length 860-4 of the inlet channel 836 extending from the third length 860-3 may have a fourth slope. The fourth slope may be greater than the third slope. A fifth length 860-5 of the inlet channel 836 extending from the fourth length 860-4 may have a fifth slope. The fifth slope may be greater than the fourth slope. A sixth length 860-6 of the inlet channel 836 extending from the fifth length 860-4 may have a sixth slope. The sixth slope may be greater than the fifth slope. In one or more embodiments, a final slope (at the second end of the inlet/outlet channel) may be less than the immediately preceding slope (the immediately preceding slope being towards the first end of the inlet/outlet channel relative to the final slope). For example, the immediately preceding slope may be the sixth slope. A relatively smaller final slope may result from manufacturing during cassette plate construction. Further, a relatively smaller final slope may allow for more uniform fluid velocity at the second end.

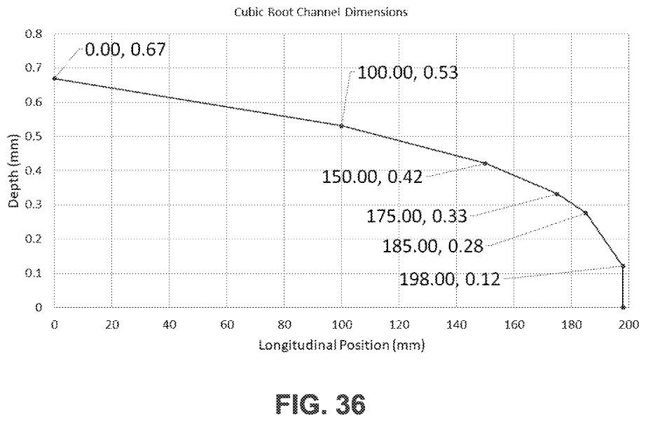

An example of a channel slope that is approximated by a corresponding cubic root channel curve is represented in the graph of FIG. 36, where the total length of the channel is 198 mm, and the initial channel depth is 0.67 mm. The depth of the channel generally decreases along the longitudinal length of the channel. The slope of the channel generally increases along the longitudinal length of the channel. In this example, the slope of the channel increases incrementally in six increments.

The outlet channel 838 can be configured similarly but may have a reverse orientation to the inlet channel 836, such that a first length 862-1 extends from the outlet distribution channel 822, a second length 862-2 extends from the first length 862-1, and so on.

### Ribs

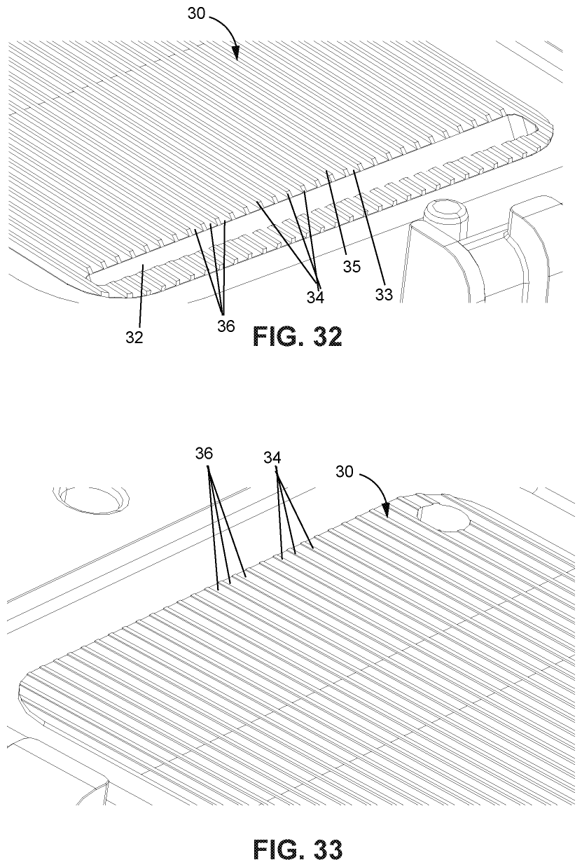

In one or more embodiments, the inlet cassette plate 814 or the outlet cassette plate 820 or both the inlet cassette plate 814 and the outlet cassette plate 820 defines a flow guide extending across the respective (inlet or outlet) channel. The flow guide may include one or more ribs, in some embodiments. The flow guide may include one or more pillars, in some embodiments. Some examples of ribs and pillars are described in detail above. Another example of a flow guide including ribs is shown in FIGS. 32 and 33, which are detail perspective views of an example channel, such as an inlet channel 836 or an outlet channel 838 of FIGS. 30-31. FIG. 32 is a detailed perspective view of an example channel 30 towards one longitudinal end of the cassette (such as cassette 810), and FIG. 33 is a detailed perspective view of the channel 30 towards the opposite longitudinal end of the cassette.

The channel 30 defines a plurality of ribs 34 extending longitudinally from the distribution channel 32 towards an opposite longitudinal end of the channel 30. A plurality of flow channels 36 are defined between adjacent pairs of ribs of the plurality of ribs 34. The ribs 34 have a depth in the axial direction from an axially-facing rib surface 35 to an axially facing channel surface 33, where the axially facing channel surface 33 is at a base of the rib. Each flow channel 36 defines a flow area through a cross-section in the longitudinal direction that is defined by rib depth and the distance between the ribs.

In the current example, the flow guide, and in particular, the plurality of ribs 34, taper in the axial direction along the length of the flow channel to define the slope discussed in detail above, such that the cross-sectional area of the flow channel decreases from the distribution channel 32 to the opposite longitudinal end of the channel 30. In some embodiments the depth of the ribs decreases from the distribution channel 32 to the opposite longitudinal end of the channel 30. The depth of the ribs may decrease incrementally, consistently with the discussion above. In some alternate embodiments, such as that depicted in FIG. 21, the lateral width of the plurality of ribs increases in a longitudinal direction, which decreases the lateral width of the flow channels in the same longitudinal direction.

### Vents

Returning to FIGS. 30-31, The inlet cassette plate 814 can define an inlet cassette vent 824 (best visible in FIG. 31). The inlet cassette vent 824 selectively defines a path for gas to vent out of the inlet cassette plate 814 in preparation for use. In various embodiments, the inlet cassette vent 824 is configured for fluid communication with the inlet channel 836. The inlet cassette vent 824 may be positioned longitudinally opposite the cassette inlet 816. The inlet cassette vent 824 may be positioned laterally opposite the cassette outlet 818. The inlet cassette vent 824 may extend diagonally outward from the cassette relative to the longitudinal and lateral directions. In some other embodiments, the vent 824 can extend axially through the inlet cassette plate 814. The inlet cassette vent 824 is generally configured to selectively open and closed to an ambient environment. Such a configuration can selectively bring the ambient environment into fluid communication with the inlet channel 836.

In various implementations the cassette 810 is bled in preparation for use, and the cassette inlet 816 is coupled to a fluid source, and fluid is introduced into the cassette inlet 816. The fluid flows from the cassette inlet 816 to the inlet channel 836 and fills the volume defined by the inlet channel 836. As the fluid fills the inlet channel 836, air (or other fluid within the inlet channel 836) is displaced and exits the cassette 810 through the inlet cassette vent 824. After the inlet channel 836 is purged of the air, the cassette vent 824 is sealed. As fluid continues to be introduced into the cassette inlet 816, the fluid flows through the separation layer 830 into the outlet channel 838, which purges air from the outlet channel 838 through the cassette outlet 818. It may be advantageous that the membrane is wet prior to bleeding.

In some other embodiments the outlet cassette plate 820 can define an outlet cassette vent in addition to or as an alternative to the inlet cassette vent 824. The outlet cassette vent selectively defines a path for air to be bled out of the outlet cassette plate in preparation for cassette use. In such embodiments, the outlet cassette plate 820 is configured to selectively define a flow path between the ambient environment and the outlet channel 838 through the outlet cassette vent. The outlet cassette vent may be positioned longitudinally opposite the cassette outlet. The outlet cassette vent may be positioned laterally opposite a cassette inlet. The outlet cassette vent may extend diagonally outward from the cassette relative to the longitudinal and lateral directions.

### Fittings

In the current example, the cassette inlet 816 is defined by a fitting 816-1 extending outward from the inlet cassette plate 814. In the current example, the inlet cassette vent 824 is defined by a fitting 824-1 extending outward from the inlet cassette plate 814. In the current example, the cassette outlet 818 is defined by a fitting 818-1 extending outward from the outlet cassette plate 820. Each of the fittings can be integrated with the corresponding cassette plate. By using fittings that extend outward from the cassette plate, dead volume through the opening can be reduced compared to designs where no fittings are coupled to the cassette and instead threaded openings are used that are configured to receive a fitting. In this example, each of the fittings can be a barbed hose fitting. The barbed hose fitting can be configured to form an interference fit with a fluid conduit.

### Channel Spacer

A channel spacer as described herein may be disposed across one or both of the inlet channel 836 and outlet channel 838. The channel spacer can be disposed across the flow guide to prevent, for example, the separation layer 830 from expanding into the adjacent flow channels. Channel spacers can be consistent with channel spacers discussed above.

### Separation Layer Seal

The cassette 810 can further include a separation layer seal 846, which has been discussed in detail above. The separation layer seal 846 may be disposed perimetrically around the separation layer 830 and axially between the inlet and outlet cassette plates. In some embodiments, the separation layer seal 846 is coupled to the separation layer 830 perimetrically around the separation layer 830. In some embodiments, the separation layer seal 846 is disposed perimetrically around the spacer layer(s) as well, such as where the spacer layer(s) are stacked with the separation layer 830. In some such embodiments, the separation layer seal 846 is coupled to the spacer layer(s) perimetrically around the spacer layer(s). In some other embodiments, a seal is defined by a relatively tight coupling of the cassette plates 814, 820 that forms a liquid tight seal via compression forces around the separation layer 830. In such an example, a separation layer seal that is a separate component from the cassette plates 814, 820 can be omitted.

### Compression Structure

In some embodiments, the inlet cassette plate 814 and the outlet cassette plate 820 can mutually define a compression structure around the inlet channel 836 and the outlet channel 838 such as discussed above with respect to FIG. 5.

### Preliminary Fastener

The cassette 810 can further include a preliminary fastener 858. The preliminary fastener 858 is generally configured to create a relatively low pressure seal among the inlet and outlet cassette plates 814, 820 and the separation layer seal 846 around the inlet and outlet channels. In this example, the preliminary fastener 858 can define, for example, a snap fit between the inlet cassette plate 814 and the outlet cassette plate 820. The preliminary fastener 858 can be positioned laterally outside of a periphery of the separation layer 830. In the current example, the preliminary fastener 858 includes a plurality of fasteners distributed perimetrically around the inlet cassette plate 814 and the outlet cassette plate 820. In this example, the outlet cassette plate 820 defines a plurality of receptacles extending axially from an outer perimetric surface of the outlet cassette plate. The inlet cassette plate 814 defines a plurality of protrusions each configured to be received by a corresponding receptacle via a snap fit.

In some other embodiments, the preliminary fastener 858 can be positioned inwardly of the outer perimetric surface of each of the inlet cassette plate and outer cassette plate. For example, in some embodiments, axially facing surfaces of the inlet cassette plate and outlet cassette plate can define a protrusion and corresponding receptacle that are configured to mutually engage via an interference fit or snap fit. In some embodiments, the preliminary fastener can form a unitary structure with the corresponding cassette plates. In some other embodiments that preliminary fastener can be separate components that are coupled to the corresponding cassette plate, such as clamps.

The preliminary fastener, when engaged, is configured to create compression between the inlet cassette plate 814 and the outlet cassette plate 820. The cassette is configured such that the compression between the inlet cassette plate 814 and the outlet cassette plate 820 is exerted on the separation layer seal 846 at an intermediate seal pressure that is less than an operating seal pressure of the cassette. The operating seal pressure may be between, for example, 2 bars and 5 bars. In some embodiments, the intermediate seal pressure is less than 2 bars or less than 1.5 bars. In some embodiments, the intermediate seal pressure results in at least 1%, 2%, 3%, 4% or 5% diametric compression of the separation layer seal 846 by the inlet cassette plate 814 and the outlet cassette plate 820. In some embodiments, the intermediate seal pressure results in a maximum of 15% diametric compression on the separation layer seal 846 by the inlet cassette plate 814 and the outlet cassette plate 820.

In various implementations, the cassette is configured such that engaging the preliminary fastener between the inlet cassette plate 814 and the outlet cassette plate 820 does not compress the separation layer across the inlet effective area and outlet effective area. The preliminary fastener may advantageously allow the cassette to be transported, stored, and the like for relatively longer periods of time without plasticly deforming the separation layer seal 846 or other elements of the cassette such as the separation layer. As such, the cassette may advantageously have a relatively increased shelf life compared to other designs.

### Alignment Features

In one or more embodiments, the cassette may include alignment features that are configured to ensure the proper orientation and alignment of the inlet cassette plate 814 and the outlet cassette plate 820, which has been discussed above. In the current example, a first pin 842 extends axially from the outlet cassette plate 820 and a first pin opening 844 extends axially through the inlet cassette plate 814. The first pin opening 844 is configured to receive the first pin 842 on a first longitudinal end 801 of the cassette 810. The cassette 810 may further include a second pin 852 extending axially from the inlet cassette plate 814 and a second pin opening 854 extending axially through the outlet cassette plate 820. The second pin opening is configured to receive the second pin 852 towards a second longitudinal end 803 of the cassette 810. As such, reversing the orientation of the inlet cassette plate and the outlet cassette plate when assembling the cassette 810 may advantageously be prevented. Other types of alignment features are also possible. For example, distributing the snap fit connectors asymmetrically around the inlet and outlet cassettes may serve as an alignment feature.

### Cassette Assembly

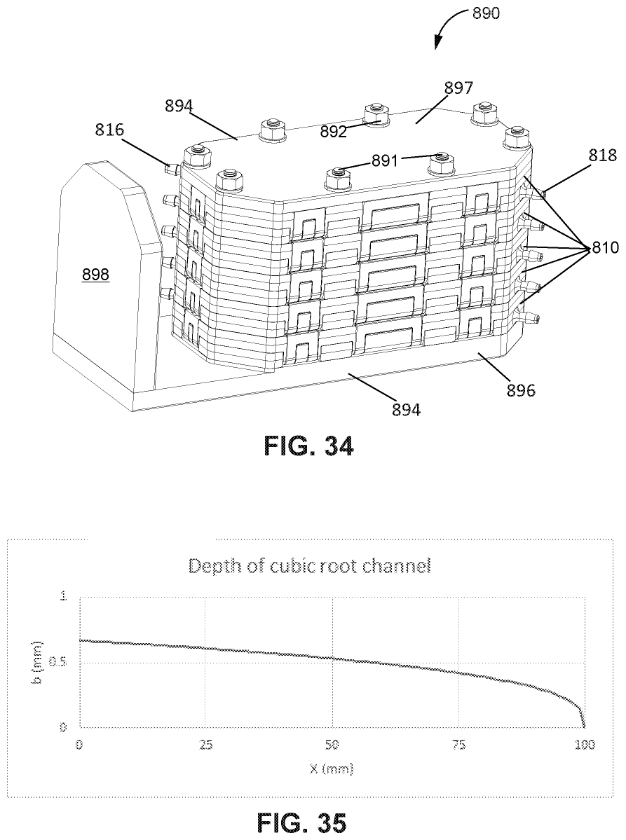

FIG. 34 illustrates a cassette assembly 890. The cassette assembly 890 includes two or more cassettes 810 and a frame 894. The cassettes 810 are generally consistent with those discussed above and are generally arranged in a stacked configuration. The cassettes 810 are stacked in the axial direction. It is noted that, while this example has five cassettes 810 arranged in a stacked configuration, in some examples a different number of cassettes can be arranged in the frame, such as a single cassette or additional cassettes.

The frame 894 is generally configured to facilitate stacking and alignment of each of the cassettes in the assembly. Furthermore, in various embodiments, the frame 894 is configured to exert an operating seal pressure on each of the cassettes 810 in the cassette assembly 890. The frame 894 is configured to exert the operating seal pressure in the axial direction. Operating seal pressure may be realized using various fasteners such as nuts 892 and bolts 891 to tighten each of the cassettes 810 together in a stacked configuration. In the current example, the frame 894 has a first end plate 896 that extends laterally and longitudinally across a first surface of the stack of cassettes 810. A plurality of bolts 891 secured to the end plate 896 extend through each of the cassettes 810. A nut 892 is coupled to a distal end of each bolt 891 and is tightened to compress the stack of cassettes to the operating seal pressure.

In some examples, including that depicted, the frame 894 has a second end plate 897 that extends laterally and longitudinally across a second surface of the stack of cassettes 810, where the second surface is opposite the first surface. Each of the plurality of bolts 891 extends through each of the cassette 810 and the second end plate 897. The nut 892 is coupled to a distal end of each bolt 891 and is tightened to compress the second end plate 897 against the stack of cassettes 810 to the operating seal pressure.

In various embodiments, the amount of diametric compression of the separation layer seal 846 resulting from engagement of the preliminary fastener will generally be less than the diametric compression of the separation layer seal 846 resulting from the application of operating seal pressure on the cassettes 810 from the cassette assembly 890. In some embodiments, the cassette assembly 890 and the cassettes 810 are configured such that the operating seal pressure results in greater than 10% or even 15% diametric compression of the separation layer seal 846. In some embodiments the operating seal pressure results in up to 30% diametric compression of the separation layer seal 846. The cassette assembly 890 and each of the cassettes 810 within the assembly are configured such that, when the operating seal pressure is applied to the stack of cassettes 810 by the frame, the frame 894, through the inlet cassette plates and outlet cassette plates, exerts 2 to 4 bars of pressure on the separation layer (830, FIG. 30). The pressure on the separation layer may result in 5% to 40% or 10% to 30% axial compression in the separation layer. In various embodiments, the axially-facing surfaces (element 35 in FIG. 32) of the plurality of ribs (element 34 in FIG. 32) may exert the pressure on the separation layer (830) through the corresponding channel spacers. Such compression may advantageously prevent deformation of the separation layer (830) in operation, which may advantageously improve device operation by maintaining consistent fluid flow.

It is noted that FIG. 11, discussed in detail above, depicts an example alternate configuration, where bolts are disposed through the two end plates outside of the stack of cassettes (instead of through the stack of cassettes). Such a frame configuration can likewise be used to exert an operating pressure of the stack of cassettes.

Returning back to FIG. 34, the inlets of each cassette may be configured to connect to a single fluid source, to allow for parallel fluid flow through all of the cassettes 810 simultaneously. In some examples, the outlets of each cassette may be configured to connect to a single conduit, tank, or the like.

In the current example, the frame 894 has a base 898 that extends axially outward from the first end plate 896 in a direction transverse to the first end plate 896. The base 898 extends in a direction toward the second end plate 897. In some implementations, the base 898 is configured to rest on a substantially horizontal surface (such as a floor or a table). Such a configuration may advantageously reduce the footprint of the cassette assembly 890. In various embodiments the base 898 is configured to extend beyond the second end plate 897. Such a configuration may advantageously position the base 898 under the center of gravity of the assembly 890.

Further, in some embodiments, the cassette assembly 890 is configured such that, when the base 898 rests on a horizontal surface, each cassette inlet 816 is oriented vertically below each corresponding cassette outlet 818, where a “corresponding” cassette outlet is the cassette outlet 818 of the same cassette 810. Further, in some such embodiments, each inlet cassette vent (824, visible in FIG. 30) is positioned vertically above each corresponding cassette inlet 816. Such a configuration may advantageously lessen the opportunity for air pockets to be trapped in the assembly as the assembly is prepared to use. In particular, liquid is introduced into the assembly towards the bottom (through the cassette inlets 816), and air is pushed upward by the liquid to exit the assembly through one or both of the cassette outlet 818 and the inlet cassette vent (824, FIG. 30).

Regardless of orientation, in the current example, each cassette inlet 816 is positioned towards the base 898 relative to the corresponding cassette outlet 818. In particular, each cassette inlet 816 is positioned closer to the base 898 in the longitudinal direction than the corresponding cassette outlet 818 of the cassette 810.

### Exemplary Aspects

Aspect 1. A cassette comprising:
an inlet cassette plate defining a cassette inlet and an inlet channel in fluid communication with the cassette inlet, the inlet channel extending across the inlet cassette plate, wherein the inlet channel defines an inlet channel depth in an axial direction;
an outlet cassette plate configured to be arranged in a stack with the inlet cassette plate, the outlet cassette plate defining a cassette outlet opposite the cassette inlet in a longitudinal direction and an outlet channel in fluid communication with the cassette outlet, wherein the outlet channel extends across the outlet cassette plate, wherein the outlet channel defines an outlet channel depth in the axial direction; and
a separation layer disposed between the inlet cassette plate and the outlet cassette plate,
wherein the inlet channel is in fluid communication with the outlet channel through the separation layer to form an assembly flow path,
wherein the inlet channel extends along an effective inlet surface area of the separation layer and the outlet channel extends along an effective outlet surface area of the separation layer, and
wherein the inlet channel depth defines an inlet slope in the longitudinal direction, and the outlet channel depth defines an outlet slope in the longitudinal direction.

Aspect 2. The cassette of any one of aspects 1 and 3-29, wherein the inlet slope increases in the longitudinal direction from the cassette inlet towards the cassette outlet.

Aspect 3. The cassette of any one of aspects 1-2 and 4-29, wherein the outlet slope decreases in the longitudinal direction from the cassette inlet towards the cassette outlet.

Aspect 4. The cassette of any one of aspects 1-3 and 5-29, further comprising an inlet cassette vent defined by the inlet cassette plate, wherein the inlet cassette vent is longitudinally opposite the cassette inlet and laterally opposite the cassette outlet.

Aspect 5. The cassette of aspect 4, wherein the inlet cassette vent extends diagonally relative to the longitudinal direction and a lateral direction.

Aspect 6. The cassette of any one of aspects 1-5 and 7-29, further comprising an outlet cassette vent defined by the outlet cassette plate, wherein the outlet cassette vent is longitudinally opposite the cassette outlet and laterally opposite the cassette inlet.

Aspect 7. The cassette of aspect 6, wherein the outlet cassette vent extends diagonally relative to the longitudinal direction and a lateral direction.

Aspect 8. The cassette of any one of aspects 1-7 and 9-29, wherein the cassette inlet extends diagonally relative to the longitudinal direction and a lateral direction.

Aspect 9. The cassette of any one of aspects 1-8 and 10-29, wherein the cassette outlet extends diagonally relative to the longitudinal direction and a lateral direction.

Aspect 10. The cassette of any one of aspects 1-9 and 11-29, wherein the inlet cassette plate defines an inlet flow guide extending into the inlet channel such that the inlet channel is tapered.

Aspect 11. The cassette of aspect 10, wherein the inlet flow guide comprises at least one structure in the group consisting of: a rib and a pillar.

Aspect 12. The cassette of aspect 10, wherein the inlet flow guide comprises a plurality of ribs extending in the longitudinal direction from the cassette inlet to the cassette outlet.

Aspect 13. The cassette of any one of aspects 1-12 and 14-29, wherein the outlet cassette plate defines an outlet flow guide extending into the outlet channel such that the outlet channel is tapered.

Aspect 14. The cassette of aspect 13, wherein the outlet flow guide comprises at least one structure in the group consisting of: a rib and a pillar.

Aspect 15. The cassette of aspect 13, wherein the outlet flow guide comprises a plurality of ribs extending in the longitudinal direction from the cassette inlet to the cassette outlet.

Aspect 16. The cassette of any one of aspects 1-15 and 17-29, further comprising a first pin extending axially from the outlet cassette plate and a first pin opening extending axially through the inlet cassette plate, wherein the first pin opening is configured to receive the first pin on a first longitudinal end of the cassette.

Aspect 17. The cassette of any one of aspects 1-16 and 18-29, further comprising a second pin extending axially from the inlet cassette plate and a second pin opening extending axially through the outlet cassette plate, wherein the second pin opening is configured to receive the second pin on a second longitudinal end of the cassette.

Aspect 18. The cassette of any one of aspects 1-17 and 19-29, wherein the inlet cassette plate and the outlet cassette plate define a snap fit.

Aspect 19. The cassette of aspect 18, wherein, when the snap fit is engaged, a maximum of 5 bar pressure is exerted on the separation layer by the inlet cassette plate or the outlet cassette plate.

Aspect 20. The cassette of aspect 18, further comprising a separation layer seal disposed perimetrically around the separation layer axially between the inlet cassette plate and the outlet cassette plate, and wherein, when the snap fit is engaged, a maximum of 15% diametric compression is exerted on the separation layer seal by the inlet cassette plate or the outlet cassette plate.

Aspect 21. The cassette of aspect 18, wherein the snap fit, when engaged, achieves an intermediate seal pressure that is less than an operating seal pressure of the cassette.

Aspect 22. The cassette of any one of aspects 1-21 and 23-29, wherein the cassette inlet is defined by a hose barb fitting extending outward from the inlet cassette plate.

Aspect 23. The cassette of any one of aspects 1-22 and 24-29, wherein the cassette outlet is defined by a hose barb fitting extending outward from the outlet cassette plate.

Aspect 24. The cassette of aspect 4, wherein the inlet cassette vent is defined by a hose barb fitting extending outward from the inlet cassette plate.

Aspect 25. The cassette of aspect 6, wherein the outlet cassette vent is defined by a hose barb fitting extending outward from the outlet cassette plate.

Aspect 26. The cassette of any one of aspects 1-25 and 27-29, wherein the inlet cassette plate defines an inlet distribution channel extending laterally from the cassette inlet.

Aspect 27. The cassette of aspect 26, wherein the inlet distribution channel narrows along its extension from the cassette inlet.

Aspect 28. The cassette of any one of aspects 1-27 and 29, wherein the outlet cassette plate defines an outlet distribution channel extending laterally from the cassette outlet.

Aspect 29. The cassette of aspect 28, wherein the outlet distribution channel narrows along its extension from the cassette outlet.

Aspect 30. A cassette comprising:
an inlet cassette plate defining a cassette inlet and an inlet channel in fluid communication with the cassette inlet, the inlet channel extending across the inlet cassette plate, wherein the inlet channel defines an inlet channel depth in an axial direction and the cassette inlet extends diagonally relative to a longitudinal direction and a lateral direction;
an outlet cassette plate configured to be arranged in a stack with the inlet cassette plate, the outlet cassette plate defining a cassette outlet opposite the cassette inlet in the longitudinal direction and an outlet channel in fluid communication with the cassette outlet, wherein the outlet channel extends across the outlet cassette plate, wherein the outlet channel defines an outlet channel depth in the axial direction, and the cassette outlet extends diagonally relative to the longitudinal and lateral directions; and
a separation layer disposed between the inlet cassette plate and the outlet cassette plate,
wherein the inlet channel is in fluid communication with the outlet channel through the separation layer to form an assembly flow path,
wherein the inlet channel extends along an effective inlet surface area of the separation layer and the outlet channel extends along an effective outlet surface area of the separation layer.

Aspect 31. The cassette of any one of aspects 30 and 32-59, wherein the inlet channel depth defines an inlet slope in the longitudinal direction, and the outlet channel depth defines an outlet slope in the longitudinal direction.

Aspect 32. The cassette of aspect 31, wherein the inlet slope increases in the longitudinal direction from the cassette inlet towards the cassette outlet.

Aspect 33. The cassette of aspect 31, wherein the outlet slope decreases in the longitudinal direction from the cassette inlet towards the cassette outlet.

Aspect 34. The cassette of any one of aspects 30-33 and 35-59, further comprising an inlet cassette vent defined by the inlet cassette plate, wherein the inlet cassette vent is longitudinally opposite the cassette inlet and laterally opposite the cassette outlet.

Aspect 35. The cassette of aspect 34, wherein the inlet cassette vent extends diagonally relative to the longitudinal direction and a lateral direction.

Aspect 36. The cassette of any one of aspects 30-35 and 37-59, further comprising an outlet cassette vent defined by the outlet cassette plate, wherein the outlet cassette vent is longitudinally opposite the cassette outlet and laterally opposite the cassette inlet.

Aspect 37. The cassette of aspect 36, wherein the outlet cassette vent extends diagonally relative to the longitudinal direction and a lateral direction.

Aspect 38. The cassette of any one of aspects 30-37 and 39-59, wherein the cassette inlet extends diagonally relative to the longitudinal direction and a lateral direction.

Aspect 39. The cassette of any one of aspects 30-38 and 40-59, wherein the cassette outlet extends diagonally relative to the longitudinal direction and a lateral direction.

Aspect 40. The cassette of any one of aspects 30-39 and 41-59, wherein the inlet cassette plate defines an inlet flow guide extending into the inlet channel such that the inlet channel is tapered.

Aspect 41. The cassette of aspect 40, wherein the inlet flow guide comprises at least one structure in the group consisting of: a rib and a pillar.

Aspect 42. The cassette of aspect 40, wherein the inlet flow guide comprises a plurality of ribs extending in the longitudinal direction from the cassette inlet to the cassette outlet.

Aspect 43. The cassette of any one of aspects 30-42 and 44-59, wherein the outlet cassette plate defines an outlet flow guide extending into the outlet channel such that the outlet channel is tapered.

Aspect 44. The cassette of aspect 43, wherein the outlet flow guide comprises at least one structure in the group consisting of: a rib and a pillar.

Aspect 45. The cassette of aspect 43, wherein the outlet flow guide comprises a plurality of ribs extending in the longitudinal direction from the cassette inlet to the cassette outlet.

Aspect 46. The cassette of any one of aspects 30-45 and 47-59, further comprising a first pin extending axially from the outlet cassette plate and a first pin opening extending axially through the inlet cassette plate, wherein the first pin opening is configured to receive the first pin on a first longitudinal end of the cassette.

Aspect 47. The cassette of any one of aspects 30-46 and 48-59, further comprising a second pin extending axially from the inlet cassette plate and a second pin opening extending axially through the outlet cassette plate, wherein the second pin opening is configured to receive the second pin on a second longitudinal end of the cassette.

Aspect 48. The cassette of any one of aspects 30-47 and 49-59, wherein the inlet cassette plate and the outlet cassette plate define a snap fit.

Aspect 49. The cassette of aspect 48, wherein, when the snap fit is engaged, a maximum of 5 bar pressure is exerted on the separation layer by the inlet cassette plate or the outlet cassette plate.

Aspect 50. The cassette of aspect 48, further comprising a separation layer seal disposed perimetrically around the separation layer axially between the inlet cassette plate and the outlet cassette plate, and wherein, when the snap fit is engaged, a maximum of 15% diametric compression is exerted on the separation layer seal by the inlet cassette plate or the outlet cassette plate.

Aspect 51. The cassette of aspect 48, wherein the snap fit, when engaged, achieves an intermediate seal pressure that is less than an operating seal pressure of the cassette.

Aspect 52. The cassette of any one of aspects 30-51 and 53-59, wherein the cassette inlet is defined by a hose barb fitting extending outward from the inlet cassette plate.

Aspect 53. The cassette of any one of aspects 30-52 and 54-59, wherein the cassette outlet is defined by a hose barb fitting extending outward from the outlet cassette plate.

Aspect 54. The cassette of aspect 34, wherein the inlet cassette vent is defined by a hose barb fitting extending outward from the inlet cassette plate.

Aspect 55. The cassette of aspect 36, wherein the outlet cassette vent is defined by a hose barb fitting extending outward from the outlet cassette plate.

Aspect 56. The cassette of any one of aspects 30-55 and 57-59, wherein the inlet cassette plate defines an inlet distribution channel extending laterally from the cassette inlet.

Aspect 57. The cassette of aspect 56, wherein the inlet distribution channel narrows along its extension from the cassette inlet.

Aspect 58. The cassette of any one of aspects 30-57 and 59, wherein the outlet cassette plate defines an outlet distribution channel extending laterally from the cassette outlet.

Aspect 59. The cassette of aspect 58, wherein the outlet distribution channel narrows along its extension from the cassette outlet.

Aspect 60. A cassette comprising:
an inlet cassette plate defining a cassette inlet, an inlet distribution channel extending laterally across the inlet cassette plate from the cassette inlet, and an inlet channel extending longitudinally from the inlet distribution channel across the inlet cassette plate, wherein the inlet channel defines an inlet channel depth in an axial direction, and wherein the inlet distribution channel narrows from the cassette inlet;
an outlet cassette plate configured to be arranged in a stack with the inlet cassette plate, the outlet cassette plate defining a cassette outlet opposite the cassette inlet in a longitudinal direction, an outlet distribution channel extending laterally across the outlet cassette plate from the cassette outlet, and an outlet channel extending longitudinally from the outlet distribution channel across the outlet cassette plate, wherein the outlet channel defines an outlet channel depth in the axial direction, and wherein the outlet distribution channel narrows from the cassette outlet; and
a separation layer disposed between the inlet cassette plate and the outlet cassette plate,
wherein the inlet channel is in fluid communication with the outlet channel through the separation layer to form an assembly flow path,
wherein the inlet channel extends along an effective inlet surface area of the separation layer and the outlet channel extends along an effective outlet surface area of the separation layer.

Aspect 61. The cassette of any one of aspects 60 and 62-89, wherein the inlet channel depth defines an inlet slope in the longitudinal direction, and the outlet channel depth defines an outlet slope in the longitudinal direction.

Aspect 62. The cassette of aspect 61, wherein the inlet slope increases in the longitudinal direction from the cassette inlet towards the cassette outlet.

Aspect 63. The cassette of aspect 61, wherein the outlet slope decreases in the longitudinal direction from the cassette inlet towards the cassette outlet.

Aspect 64. The cassette of any one of aspects 60-63 and 65-89, further comprising an inlet cassette vent defined by the inlet cassette plate, wherein the inlet cassette vent is longitudinally opposite the cassette inlet and laterally opposite the cassette outlet.

Aspect 65. The cassette of aspect 64, wherein the inlet cassette vent extends diagonally relative to the longitudinal direction and a lateral direction.

Aspect 66. The cassette of any one of aspects 60-65 and 67-89, further comprising an outlet cassette vent defined by the outlet cassette plate, wherein the outlet cassette vent is longitudinally opposite the cassette outlet and laterally opposite the cassette inlet.

Aspect 67. The cassette of aspect 66, wherein the outlet cassette vent extends diagonally relative to the longitudinal direction and a lateral direction.

Aspect 68. The cassette of any one of aspects 60-67 and 69-89, wherein the cassette inlet extends diagonally relative to the longitudinal direction and a lateral direction.

Aspect 69. The cassette of any one of aspects 60-68 and 70-89, wherein the cassette outlet extends diagonally relative to the longitudinal direction and a lateral direction.

Aspect 70. The cassette of any one of aspects 60-69 and 71-89, wherein the inlet cassette plate defines an inlet flow guide extending into the inlet channel such that the inlet channel is tapered.

Aspect 71. The cassette of aspect 70, wherein the inlet flow guide comprises at least one structure in the group consisting of: a rib and a pillar.

Aspect 72. The cassette of aspect 70, wherein the inlet flow guide comprises a plurality of ribs extending in the longitudinal direction from the cassette inlet to the cassette outlet.

Aspect 73. The cassette of any one of aspects 60-72 and 74-89, wherein the outlet cassette plate defines an outlet flow guide extending into the outlet channel such that the outlet channel is tapered.

Aspect 74. The cassette of aspect 73, wherein the outlet flow guide comprises at least one structure in the group consisting of: a rib and a pillar.

Aspect 75. The cassette of aspect 73, wherein the outlet flow guide comprises a plurality of ribs extending in the longitudinal direction from the cassette inlet to the cassette outlet.

Aspect 76. The cassette of any one of aspects 60-75 and 77-89, further comprising a first pin extending axially from the outlet cassette plate and a first pin opening extending axially through the inlet cassette plate, wherein the first pin opening is configured to receive the first pin on a first longitudinal end of the cassette.

Aspect 77. The cassette of any one of aspects 60-76 and 78-89, further comprising a second pin extending axially from the inlet cassette plate and a second pin opening extending axially through the outlet cassette plate, wherein the second pin opening is configured to receive the second pin on a second longitudinal end of the cassette.

Aspect 78. The cassette of any one of aspects 60-77 and 79-89, wherein the inlet cassette plate and the outlet cassette plate define a snap fit.

Aspect 79. The cassette of aspect 78, wherein, when the snap fit is engaged, a maximum of 5 bar pressure is exerted on the separation layer by the inlet cassette plate or the outlet cassette plate.

Aspect 80. The cassette of aspect 78, further comprising a separation layer seal disposed perimetrically around the separation layer axially between the inlet cassette plate and the outlet cassette plate, and wherein, when the snap fit is engaged, a maximum of 15% diametric compression is exerted on the separation layer seal by the inlet cassette plate or the outlet cassette plate.

Aspect 81. The cassette of aspect 78, wherein the snap fit, when engaged, achieves an intermediate seal pressure that is less than an operating seal pressure of the cassette.

Aspect 82. The cassette of any one of aspects 60-81 and 83-89, wherein the cassette inlet is defined by a hose barb fitting extending outward from the inlet cassette plate.

Aspect 83. The cassette of any one of aspects 60-82 and 84-89, wherein the cassette outlet is defined by a hose barb fitting extending outward from the outlet cassette plate.

Aspect 84. The cassette of aspect 64, wherein the inlet cassette vent is defined by a hose barb fitting extending outward from the inlet cassette plate.

Aspect 85. The cassette of aspect 66, wherein the outlet cassette vent is defined by a hose barb fitting extending outward from the outlet cassette plate.

Aspect 86. The cassette of any one of aspects 60-85 and 87-89, wherein the inlet cassette plate defines an inlet distribution channel extending laterally from the cassette inlet.

Aspect 87. The cassette of aspect 86, wherein the inlet distribution channel narrows along its extension from the cassette inlet.

Aspect 88. The cassette of any one of aspects 60-87 and 89, wherein the outlet cassette plate defines an outlet distribution channel extending laterally from the cassette outlet.

Aspect 89. The cassette of aspect 88, wherein the outlet distribution channel narrows along its extension from the cassette outlet.

Aspect 90. A cassette comprising:
an inlet cassette plate defining a cassette inlet and an inlet channel in fluid communication with the cassette inlet, the inlet channel extending across the inlet cassette plate, wherein the inlet channel defines an inlet channel depth in an axial direction;
an outlet cassette plate configured to be arranged in a stack with the inlet cassette plate, the outlet cassette plate defining a cassette outlet opposite the cassette inlet in a longitudinal direction and an outlet channel in fluid communication with the cassette outlet, wherein the outlet channel extends across the outlet cassette plate, wherein the outlet channel defines an outlet channel depth in the axial direction, wherein the inlet cassette plate and the outlet cassette plate define a snap fit;
a separation layer disposed between the inlet cassette plate and the outlet cassette plate; and
a seal disposed perimetrically around the separation layer axially between the inlet cassette plate and the outlet cassette plate, wherein the snap fit, when engaged, achieves an intermediate seal pressure that is less than an operating seal pressure of the cassette,
wherein the inlet channel is in fluid communication with the outlet channel through the separation layer to form an assembly flow path, and
wherein the inlet channel extends along an effective inlet surface area of the separation layer and the outlet channel extends along an effective outlet surface area of the separation layer.

Aspect 91. The cassette of any one of aspects 90 and 92-119, wherein the inlet channel defines an inlet slope in the longitudinal direction, and the outlet channel defines an outlet slope in the longitudinal direction.

Aspect 92. The cassette of aspect 91, wherein the inlet slope increases in the longitudinal direction from the cassette inlet towards the cassette outlet.

Aspect 93. The cassette of aspect 91, wherein the outlet slope decreases in the longitudinal direction from the cassette inlet towards the cassette outlet.

Aspect 94. The cassette of any one of aspects 90-93 and 95-119, further comprising an inlet cassette vent defined by the inlet cassette plate, wherein the inlet cassette vent is longitudinally opposite the cassette inlet and laterally opposite the cassette outlet.

Aspect 95. The cassette of aspect 94, wherein the inlet cassette vent extends diagonally relative to the longitudinal direction and a lateral direction.

Aspect 96. The cassette of any one of aspects 90-95 and 97-119, further comprising an outlet cassette vent defined by the outlet cassette plate, wherein the outlet cassette vent is longitudinally opposite the cassette outlet and laterally opposite the cassette inlet.

Aspect 97. The cassette of aspect 96, wherein the outlet cassette vent extends diagonally relative to the longitudinal direction and a lateral direction.

Aspect 98. The cassette of any one of aspects 90-97 and 99-119, wherein the cassette inlet extends diagonally relative to the longitudinal direction and a lateral direction.

Aspect 99. The cassette of any one of aspects 90-98 and 100-119, wherein the cassette outlet extends diagonally relative to the longitudinal direction and a lateral direction.

Aspect 100. The cassette of any one of aspects 90-99 and 101-119, wherein the inlet cassette plate defines an inlet flow guide extending into the inlet channel such that the inlet channel is tapered.

Aspect 101. The cassette of aspect 100, wherein the inlet flow guide comprises at least one structure in the group consisting of: a rib and a pillar.

Aspect 102. The cassette of aspect 100, wherein the inlet flow guide comprises a plurality of ribs extending in the longitudinal direction from the cassette inlet to the cassette outlet.

Aspect 103. The cassette of any one of aspects 90-102 and 104-119, wherein the outlet cassette plate defines an outlet flow guide extending into the outlet channel such that the outlet channel is tapered.

Aspect 104. The cassette of aspect 103, wherein the outlet flow guide comprises at least one structure in the group consisting of: a rib and a pillar.

Aspect 105. The cassette of aspect 103, wherein the outlet flow guide comprises a plurality of ribs extending in the longitudinal direction from the cassette inlet to the cassette outlet.

Aspect 106. The cassette of any one of aspects 90-105 and 107-119, further comprising a first pin extending axially from the outlet cassette plate and a first pin opening extending axially through the inlet cassette plate, wherein the first pin opening is configured to receive the first pin on a first longitudinal end of the cassette.

Aspect 107. The cassette of any one of aspects 90-106 and 108-119, further comprising a second pin extending axially from the inlet cassette plate and a second pin opening extending axially through the outlet cassette plate, wherein the second pin opening is configured to receive the second pin on a second longitudinal end of the cassette.

Aspect 108. The cassette of any one of aspects 90-107 and 109-119, wherein the inlet cassette plate and the outlet cassette plate define a snap fit.

Aspect 109. The cassette of aspect 108, wherein, when the snap fit is engaged, a maximum of 5 bar pressure is exerted on the separation layer by the inlet cassette plate or the outlet cassette plate.

Aspect 110. The cassette of aspect 108, further comprising a separation layer seal disposed perimetrically around the separation layer axially between the inlet cassette plate and the outlet cassette plate, and wherein, when the snap fit is engaged, a maximum of 15% diametric compression is exerted on the separation layer seal by the inlet cassette plate or the outlet cassette plate.

Aspect 111. The cassette of aspect 108, wherein the snap fit, when engaged, achieves an intermediate seal pressure that is less than an operating seal pressure of the cassette.

Aspect 112. The cassette of any one of aspects 90-111 and 113-119, wherein the cassette inlet is defined by a hose barb fitting extending outward from the inlet cassette plate.

Aspect 113. The cassette of any one of aspects 90-112 and 114-119, wherein the cassette outlet is defined by a hose barb fitting extending outward from the outlet cassette plate.

Aspect 114. The cassette of aspect 94, wherein the inlet cassette vent is defined by a hose barb fitting extending outward from the inlet cassette plate.

Aspect 115. The cassette of aspect 96, wherein the outlet cassette vent is defined by a hose barb fitting extending outward from the outlet cassette plate.

Aspect 116. The cassette of any one of aspects 90-115 and 117-119, wherein the inlet cassette plate defines an inlet distribution channel extending laterally from the cassette inlet.

Aspect 117. The cassette of aspect 116, wherein the inlet distribution channel narrows along its extension from the cassette inlet.

Aspect 118. The cassette of any one of aspects 90-117 and 119, wherein the outlet cassette plate defines an outlet distribution channel extending laterally from the cassette outlet.

Aspect 119. The cassette of aspect 118, wherein the outlet distribution channel narrows along its extension from the cassette outlet.

Aspect 120. A cassette assembly comprising:
a first end plate extending in a longitudinal direction and a lateral direction;
a second end plate configured to be coupled to the first end plate, wherein the second end plate extends in the longitudinal direction and the lateral direction;
a base extending axially outward from the first end plate towards the second end plate, wherein the base is configured to rest on a planar surface; and
a cassette configured to be disposed between the first end plate and the second end plate, wherein the first end plate and the second end plate are configured to exert a compression force on the cassette.

Aspect 121. The cassette assembly of any one of aspects 120 and 122-125, wherein the cassette comprises a cassette inlet and a cassette outlet, wherein the cassette inlet is positioned towards the base relative to the cassette outlet.

Aspect 122. The cassette assembly of any one of aspects 120-121 and 123-125, wherein the cassette inlet is configured to be positioned vertically below the cassette outlet when the base rests on a planar surface.

Aspect 123. The cassette assembly of any one of aspects 120-122 and 124-125, wherein the base is configured to extend beyond the second end plate.

Aspect 124. The cassette assembly of any one of aspects 120-123 and 125, further comprising a plurality of fasteners, wherein the cassette, the first end plate, and the second end plate each define a plurality of aligned fastener openings that are configured to receive each of the plurality of fasteners.

Aspects 125. The cassette assembly of any one of aspects 120-124, further comprising one or more additional cassettes, wherein each of the one or more additional cassettes are configured to be arranged in a stacked configuration between the first end plate and the second end plate.

It should be noted that, as used in this specification and the appended claims, the phrase “configured” describes a system, apparatus, or other structure that is constructed to perform a particular task or adopt a particular configuration. The word “configured” can be used interchangeably with similar words such as “arranged,” “constructed,” “manufactured,” and the like.

All publications and patent applications in this specification are indicative of the level of ordinary skill in the art to which this technology pertains. All publications and patent applications are herein incorporated by reference to the same extent as if each individual publication or patent application was specifically and individually indicated by reference. In the event that any inconsistency exists between the disclosure of the present application and the disclosure(s) of any document incorporated herein by reference, the disclosure of the present application shall govern.

This application is intended to cover adaptations or variations of the present subject matter. It is to be understood that the above description is intended to be illustrative, and not restrictive, and the claims are not limited to the illustrative embodiments as set forth herein.

What is claimed is:

1. A cassette comprising:
an inlet cassette plate defining a cassette inlet and an inlet channel in fluid communication with the cassette inlet, the inlet channel extending across the inlet cassette plate, wherein the inlet channel defines an inlet channel depth in an axial direction;
an outlet cassette plate configured to be arranged in a stack with the inlet cassette plate, the outlet cassette plate defining a cassette outlet opposite the cassette inlet in a longitudinal direction and an outlet channel in fluid communication with the cassette outlet, wherein the outlet channel extends across the outlet cassette plate, wherein the outlet channel defines an outlet channel depth in the axial direction, wherein the inlet cassette plate and the outlet cassette plate define a snap fit;
a separation layer disposed between the inlet cassette plate and the outlet cassette plate; and
a seal disposed perimetrically around the separation layer axially between the inlet cassette plate and the outlet cassette plate, wherein the snap fit, when engaged, achieves an intermediate seal pressure that is less than an operating seal pressure of the cassette,
wherein the inlet channel is in fluid communication with the outlet channel through the separation layer to form an assembly flow path, and
wherein the inlet channel extends along an effective inlet surface area of the separation layer and the outlet channel extends along an effective outlet surface area of the separation layer.

2. The cassette of claim 1, wherein the inlet channel defines an inlet slope in the longitudinal direction, and the outlet channel defines an outlet slope in the longitudinal direction.

3. The cassette of claim 2, wherein the inlet slope increases in the longitudinal direction from the cassette inlet towards the cassette outlet.

4. The cassette of claim 1, further comprising an inlet cassette vent defined by the inlet cassette plate, wherein the inlet cassette vent is longitudinally opposite the cassette inlet and laterally opposite the cassette outlet.

5. The cassette of claim 4, wherein the inlet cassette vent extends diagonally relative to the longitudinal direction and a lateral direction.

6. The cassette of claim 1, wherein the cassette inlet extends diagonally relative to the longitudinal direction and a lateral direction.

7. The cassette of claim 1, wherein the cassette outlet extends diagonally relative to the longitudinal direction and a lateral direction.

8. The cassette of claim 1, wherein the inlet cassette plate defines an inlet flow guide extending into the inlet channel such that the inlet channel is tapered.

9. The cassette of claim 1, wherein the outlet cassette plate defines an outlet flow guide extending into the outlet channel such that the outlet channel is tapered.

10. The cassette of claim 1, further comprising a first pin extending axially from the outlet cassette plate and a first pin opening extending axially through the inlet cassette plate, wherein the first pin opening is configured to receive the first pin on a first longitudinal end of the cassette.

11. The cassette of claim 1, further comprising a second pin extending axially from the inlet cassette plate and a second pin opening extending axially through the outlet cassette plate, wherein the second pin opening is configured to receive the second pin on a second longitudinal end of the cassette.

12. The cassette of claim 1, wherein, when the snap fit is engaged, a maximum of 5 bar pressure is exerted on the separation layer by the inlet cassette plate or the outlet cassette plate.

13. The cassette of claim 1, further comprising a separation layer seal disposed perimetrically around the separation layer axially between the inlet cassette plate and the outlet cassette plate, and wherein, when the snap fit is engaged, a maximum of 15% diametric compression is exerted on the separation layer seal by the inlet cassette plate or the outlet cassette plate.

14. The cassette of claim 1, wherein the cassette inlet is defined by a hose barb fitting extending outward from the inlet cassette plate.

15. The cassette of claim 1, wherein the cassette outlet is defined by a hose barb fitting extending outward from the outlet cassette plate.

16. The cassette of claim 4, wherein the inlet cassette vent is defined by a hose barb fitting extending outward from the inlet cassette plate.

17. The cassette of claim 1, wherein the inlet cassette plate defines an inlet distribution channel extending laterally from the cassette inlet.

18. The cassette of claim 17, wherein the inlet distribution channel narrows along its extension from the cassette inlet.

19. The cassette of claim 1, wherein the outlet cassette plate defines an outlet distribution channel extending laterally from the cassette outlet.

20. The cassette of claim 19, wherein the outlet distribution channel narrows along its extension from the cassette outlet.
